(19) United States
(12) Patent Application Publication
(10) Pub. No.: US 2026/0037279 A1
(43) Pub. Date: Feb. 5, 2026

(54) ISSUE TRACKING PLATFORM HAVING A GENERATIVE INTERFACE USING ISSUE DATA

(71) Applicant: Atlassian Pty Ltd., Sydney (AU)

(72) Inventors: Shihab Hamid, Sydney (AU); David Wilson, Sydney (AU); Ankesh Khemani, Karnataka (IN); Akshar Prasad, Karnataka (IN)

(21) Appl. No.: 18/788,605

(22) Filed: Jul. 30, 2024

(51) Int. Cl. G06F 9/451; G06F 40/30

(52) U.S. Cl. CPC G06F 9/451; G06F 40/30

(57) ABSTRACT

Embodiments described herein relate to systems and methods for providing generative content for a graphical user interface of an issue tracking platform. The systems and methods can include generating a first prompt including a set of similar issues to a particular issue, and a request to extract actions performed for each issue of the set of similar issues. In response to providing the first prompt to a generative output engine, receiving a first generative response produced. In response to receiving the first generative response, a second prompt can be generated and include issue data extracted from the particular issue, the summary of actions received as part of the first generative response, and predetermined prompt language associated with a recommendation. A recommendation panel can be displayed and include content generated using the second generative response.

### TECHNICAL FIELD

Embodiments described herein relate to multi-tenant services of collaborative work environments and, in particular, to systems and methods for operating a generative answer interface that produces generative content based on multi-platform content resources.

### BACKGROUND

An organization can employ software tools to assist with technical problems and interruptions in technical service. Typically, an issue tracking system or similar software platform may be used to track and manage technical problems logged by system users. However, the information contained in a large system may be difficult to access in an efficient interface and information that resides in disparate locations in the system or that is entered over a period of time may be difficult to compile and access when managing a large quantity of issues. The systems and techniques described herein may be used to provide improved user interfaces and content generation in a way that mitigates technical deficiencies of some traditional interfaces and systems.

### SUMMARY

Embodiments described herein are directed to computer-implemented methods for providing a recommendation panel for a graphical user interface of an issue tracking platform. The methods can include causing display of an intake portal graphical user interface of a frontend application of the issue tracking platform on a client device. In response to a user selection of a query category of the intake portal, the methods can cause creation of a particular issue, where the particular issue is assigned a request type corresponding to the query category. The methods can cause display of an issue-view graphical user interface including issue data of the particular issue, and in response to user input provided to the issue-view graphical user interface generate additional issue data including one or more transaction messages. The methods can include causing display of the recommendation panel in the issue-view graphical user interface. The recommendation panel can include a first section including a set of one or more selectable link objects, where each selectable link object is associated with a respective content item identified for the request type; a second section including a link to a user profile of a subject matter expert user, where the subject matter expert user selected is based on a subject matter determined using the issue data; and a third section including suggested action narrative. The suggested action narrative can be determined by generating a prompt including at least a portion of the one or more transaction messages and content extracted from a content item. The method can include providing the prompt to a generative output engine and generating the suggested action narrative using a generative response received from the generative output engine in response to the prompt.

Embodiments described herein are also directed to computer-implemented methods for providing generative content for a graphical user interface of an issue tracking platform. The methods can include causing display of an intake portal graphical user interface of a frontend application of the issue tracking platform on a client device, and in response to a first user input the intake portal, causing creation of a particular issue. The methods can include causing display of an issue-view graphical user interface comprising issue data of the particular issue, where the issue data comprising transaction messages associated with the particular issue. The methods can include generating a first prompt including a set of similar issues to the particular issue, where the set of similar issues are identified using semantic analysis of the issue data; and a request to extract actions performed for each issue of the set of similar issues. The methods can include receiving a first generative response produced in response to providing the first prompt to a generative output engine, where the first generative response includes a summary of actions performed for each issue of the set of similar issues. In response to receiving the first generative response, the methods can include generating a second prompt comprising issue data extracted from the particular issue, the summary of actions received as part of the first generative response, and predetermined prompt language associated with a recommendation request. The methods can include receiving a second generative response produced in response to providing the second prompt to the generative output engine, and causing display of a recommendation panel in the issue-view graphical user interface, where the recommendation panel includes content generated using the second generative response.

Embodiments are further directed to computer-implemented methods for modifying issue groups for a graphical user interface of an issue tracking platform. The methods can include causing display of an issue dashboard graphical user interface of a frontend application of the issue tracking platform on a client device. The issue dashboard graphical user interface can include multiple sets of issue tickets, where each set of issue tickets is grouped in accordance with a queue definition. In response to satisfying an activity criteria, the methods can include causing generation of a prompt. The prompt can include predetermined prompt text including a recommendation criteria, data extracted from the multiple sets of issue tickets including an issue title and assignee, and data associated with a current user account authenticated with respect to the frontend application. The methods can include receiving a generative response from a generative output engine, where the generative response is produced by the generative output engine in response to the prompt. The methods can include analyzing the generative response, and in response to the recommendation criteria being satisfied, causing display of a group modification interface including at least a portion of the generative response. In response to a user input, the methods can include causing creation of a new issue ticket group by performing a structured query on issues managed by the issue tracking platform and saving the structured query as a new queue definition. The structured query can be generated using at least a portion of the generative response.

Embodiments are further directed to computer-implemented methods for assigning issues in a graphical user interface of an issue tracking platform. The methods can include causing display of an issue dashboard graphical user interface of a frontend application of the issue tracking platform on a client device. The issue dashboard graphical user interface can include a first set of issue tickets. In response to a first user input selecting an element associated with a particular field, the methods can include causing generation of a prompt. The prompt can include predetermined prompt text including grouping instructions, data extracted from the first set of issue tickets displayed in the issue dashboard graphical user interface, and data extracted from a second set of issues each having at least one value of a defined set of values assigned to the particular field. The methods can include obtaining a generative response from a generative output engine, where the generative response is produced by the generative output engine in response to the prompt. The methods can include analyzing the generative response and causing display of a field assignment interface, where the field assignment interface includes the first set of issue tickets arranged into multiple groups of issue tickets and each group of the multiple groups is associated with a respective value. In response to a second user input, the methods can include assigning the respective value to a corresponding group of the multiple groups of issue tickets.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system, such as described herein that can include and/or may receive input from a generative output engine.

FIG. 2 depicts an example system for providing a generative answer interface for a content collaboration platform.

FIG. 3A depicts a simplified diagram of a system, such as described herein that can include and/or may receive input from a generative output engine.

FIG. 3B depicts a functional system diagram of a system that can be used to implement a multiplatform prompt management service.

FIG. 4A depicts a simplified system diagram and data processing pipeline.

FIG. 4B depicts a system providing multiplatform prompt management as a service.

FIG. 5 depicts an example process for generating a recommendation panel for an issue tracking platform.

FIG. 6A depicts an example issue-view graphical user interface including a recommendation panel for an issue tracking platform.

FIG. 6B depicts an example issue-view graphical user interface including an updated recommendation panel for the issue tracking platform.

FIG. 6C depicts an example issue-view graphical user interface including a recommendation panel for an issue tracking platform.

FIG. 7 depicts an example issue dashboard graphical user interface including a recommendation panel for an issue tracking platform.

FIG. 8A depicts an example of an issue ticket managed by an issue tracking platform.

FIG. 8B depicts an example of the issue ticket shown in FIG. 7A including activity log data that is associated with the issue.

FIG. 9 depicts a prompt that can be submitted to a generative output engine.

FIG. 10A depicts an example suggested action narrative generated using a generative response obtained from a generative output engine.

FIG. 10B depicts an example generative response obtained in response to a prompt submitted to a generative output engine.

FIG. 11 depicts an example schematic of an issue tracking platform.

FIGS. 12A-12B depicts an example portal for an issue tracking platform.

FIG. 12C depicts an example issue-creation form.

FIG. 13 depicts an example graphical user interface of an issue view in an issue tracking platform.

FIG. 14 depicts an example of an issue dashboard graphical user interface of an issue tracking platform.

FIG. 15 depicts an example of an issue dashboard graphical user interface of an issue tracking platform and having one or more updated queue definitions in response to a generative response.

FIG. 16 depicts an example of an issue dashboard graphical user interface of an issue tracking platform.

FIG. 17 depicts an example of a field assignment interface displayed in response to obtaining a generative response from a generative output engine.

FIG. 18 depicts an example of an issue dashboard graphical user interface of an issue tracking platform and having issue tickets arranged into multiple groups of issue tickets.

FIG. 19 shows a sample electrical block diagram of an electronic device.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiment described herein are related to systems and methods for generating content that can be used to progress issues managed by an issue tracking system. A user may use the issue tracking system to generate issue tickets to assist with a problem or other tasks that they need help addressing. An issue ticket can be associated with issue data, which may include a variety of information including a request type, an issue title, a summary of the issue input by the requesting user, and/or other information that is created at the time of the issue ticket. The issue tracking system may also associate other types of data with the issue ticket, which may include workflow data. The workflow data may define a series of states that the issue or task must traverse before being completed. The system may also track user interaction events (e.g., messages), issue state transitions, automations associated with the issue and other events that occur over the lifecycle of the issue, which may be indexed and searchable by the system.

The systems and methods herein may include generating a graphical user interface that can be used by an agent of the system to respond to and progress the issue towards resolution. The graphical user interface can include content for the agent and/or the requesting user to progress the issue towards resolution. In some cases, the content can include information and/or a recommendation of next steps for progressing the issue. The content may be generated from issue data related to the current issue and issue data from other issues that are managed by the system. The current issue data can include workflow data, transaction messages between a user and an agent, and other types of data associated with the issue. The other issue data may include issue data for resolved issues that are similar to the current issue.

In some cases, the content can be displayed by the graphical user interface using a recommendation panel. The recommendation panel can include a link object(s) that direct the agent and/or user to resources that are relevant to resolving the issue. In some cases, the link object(s) may be links to knowledge base pages that are managed by a knowledge base system. The link objects can be identified from the current issue data and/or issue data obtained from similar issues. For example, the system may identify knowledge base articles based on a request type associated with the issue, a title of the issue, summary data, transaction messages between the user and the agent, and/or using other suitable issue data. In some cases, the system may use a generative output engine to identify a knowledge base article (or other resource) that can be accessed using the link object.

The recommendation panel can also include a reference to a user account determined by the system to be a subject matter expert relevant to the particular issue. The system can be configured to determine a subject matter of the particular issue and use that information to identify a user account that is associated with the determined subject matter for the issue. In some cases, the system can determine the subject matter of the particular issue by analyzing issue data such as a title of the issue, a summary of the issue, a request type associated with the issue, transaction messages of the issue, performing a semantic analysis of issue data, and so on. The system may access resolved issues having a same or similar subject matter (e.g., same request type) and evaluate user accounts assigned to each issue. The system may determine a subject matter expert based on a user account that is associated with the highest number of issues having the same or similar subject matter (e.g., same request type). The reference to the user account may include an active element displayed in the graphical user interface that can be used to contact the subject matter expert. In some cases, the active element may also be configured to include information from the current issue in a message to the subject matter expert.

The recommendation panel can also include a suggested action narrative, which may be generated using issue data submitted to a generative output engine. The system may use a generative output engine to identify content and/or generate recommendations for actions that can be performed on the current issue. The system may generate a prompt for a generative output engine. The prompt can include current issue data, issue data from other issues (e.g., similar resolved issues) and instructions for the generative output engine. For example, the prompt may provide the one or more transaction messages associated with the current issue, and/or other issue data in the prompt, content from an identified knowledge base article relevant to the current issue (e.g., text based description from the knowledge base article) and a request to summarize steps to address the issue using the content. The output from the generative response can include a shortened summary and/or step-by-step instructions generated from the content object, which may be used to generate the suggested action narrative. In some cases, the suggested action narrative may include other content such as an identification of the particular issue, a link to a resource with information related to the particular issue and/or other information relative to the particular issue.

In some cases, the recommendation panel is displayed in an agent view graphical user interface for the particular issue, and the agent can review and/or approve the content contained in the recommendation panel before some or all of the content is shared with the requesting user. The recommendation panel can include a suggested response that can be provided to the user. The suggested response can be formatted as a message that can be submitted to the transaction messages associated with the issue. In some cases, the system allows an agent to modify or otherwise change the suggested response and/or the link object. For example, the agent may modify the text, remove the link object, add additional link objects and/or perform other actions that can be submitted to the issue.

Embodiments are also related to systems and methods for generating content that can be used to progress issues managed by an issue tracking system. A user may use the issue tracking system to generate issue tickets to assist with a problem or other tasks that they need help addressing. An issue ticket can be associated with issue data, which may include a variety of information including a request type, an issue title, a summary of the issue input by the requesting user, and/or other information that is created at the time of the issue ticket. The issue tracking system may also associate other types of data with the issue ticket, which may include workflow data. The workflow data may define a series of states that the issue or task must traverse before being completed. The system may also track user interaction events (e.g., messages), issue state transitions, automations associated with the issue and other events that occur over the lifecycle of the issue, which may be indexed and searchable by the system.

The systems and methods herein may include generating a graphical user interface that can be used by an agent of the system to respond to and progress the issue towards resolution. The graphical user interface can include content for the agent and/or the requesting user to progress the issue towards resolution. In some cases, the content can include information and/or a recommendation of next steps for progressing the issue. The content may be generated from issue data related to the current issue and issue data from other issues that are managed by the system. The current issue data can include workflow data, transaction messages between a user and an agent, and other types of data associated with the issue. The other issue data may include issue data for resolved issues that are similar to the current issue.

In some cases, the content can be displayed by the graphical user interface using a recommendation panel. The recommendation panel can include information for an agent user that is relevant to progressing the current issue (e.g. a suggested action narrative) and/or content that can be sent to the requesting user (e.g., formatted messages that can be sent to a user). The information contained in the recommendation panel can be generated using data from similar issues. The similar issues can be identified using issue data. The system can be configured to perform a semantic analysis on the issue data and other issues managed by the issue tracking system to identify the similar issues. The semantic analysis may be performed using machine learning techniques such as latent semantic analysis and/or any other suitable processes.

The content displayed in the recommendation panel can be generated using issue data submitted to a generative output engine. The system may use a generative output engine to identify content and/or generate recommendations for actions that can be performed on the current issue. The system may generate a prompt for a generative output engine. The prompt can include current issue data, issue data from other issues (e.g., similar resolved issues) and instructions for the generative output engine.

Each similar issue may include a variety of different data content. In many cases, it can be difficult to determine which data from a similar issue may be relevant to the particular issue and/or what issues may be more similar to the particular issue. Additionally, the particular issue may share different similarities with different portions of the other similar issues. For example, each issue that is resolved (or being resolved) using the issue tracking system may include unique data and/or a unique workflow. Accordingly, it may be rare for a current issue to have the same events/actions occur in the same order as a previous/similar issue. Additionally, different users may characterize similar problems differently, for example, by providing different titles, descriptions, characterizing the issue using different request types and so on. Accordingly, depending on a current state of an issue data from multiple different similar issues may be informative in generating a recommendation for progressing the particular issue.

The system may generate a prompt using the identified similar issues and the particular issue data. They system can use a generative output engine to extract actions/events or other data from the similar issues that are relevant to the particular issue. For example, the system may generate a first prompt that includes the set of similar issues to the particular issue identified using semantic analysis of the issue data, and a request to extract actions performed for each issue of the set of similar issues that are relevant to the current issue.

The system may use the generative response that resulted from the first prompt to generate a second prompt. The second prompt may utilize the generative output engine to generate a recommendation for progressing the particular issue by submitting the relevant information extracted from the similar issues to the generative output engine. For example, the system may generate a second prompt that includes issue data extracted from the particular issue and the summary of actions received as part of the first generative response. The second prompt can also include predetermined prompt language associated with a recommendation request. The system can cause display of a recommendation panel in the issue-view graphical user interface including content generated using the second generative response.

In some cases, the recommendation panel is displayed in an agent view graphical user interface for the particular issue, and the agent can review and/or approve the content contained in the recommendation panel before some or all of the content is shared with the requesting user. The recommendation panel can include a suggested response that can be provided to the user. The suggested response can be formatted as a message that can be submitted to the transaction messages associated with the issue. In some cases, the system allows an agent to modify or otherwise change the suggested response and/or the link object. For example, the agent may modify the text, remove the link object, add additional link objects and/or perform other actions that can be submitted to the issue.

Embodiments are further related to systems and methods for managing issue queues that can be used to organize and track issue tickets managed by an issue tracking system. Issue tickets managed by an issue tracking system may be assigned to a queue based on one or more parameters associated with the issue ticket. For example, each queue managed by the system can be associated with a queue definition that includes one or more defined parameters for determining which issues tickets are displayed in a particular queue. The queues may be used to group issue tickets by a common parameter such an agent assigned to the issue tickets, priority associated with issue tickets, due date for the issue tickets, a type of issue and so on. Accordingly, a user may select a particular queue, for example a queue that is associated with issue tickets assigned to a particular agent, and the graphical user interface can display the issues that are grouped within that queue based on the queue definition. In this example, the graphical user interface displays a queue showing all issues assigned to the particular agent.

In other cases, queue definitions may cause issues to be arranged according to other parameters including a status, priority, request type, service level agreement (SLA), and so on. Accordingly, the graphical user interface can display multiple different sets of issue tickets, where each set of issue tickets is grouped in accordance with a queue definition.

The system can be configured to collect data related to queues including monitoring activity related to each queue and analyze the data and/or activity to generate one or more recommendations for creating and/or modifying the existing queues. In some cases, the system may submit selected queue data to a generative output engine along with a request to analyze the data and suggest changes to the current queue structure. The system can use a generative output from the generative output engine to create the one or more recommendations. For example, the system may collect issue data from pending issues, which may include priority information, workflow states, issue activity, messages, SLA information, and so on. The system may submit the issue data and/or corresponding queue data to a generative output engine using a prompt. The system may also include a request such as a request to identify compliance with an SLA, identify duplicate issues across different queues, identify queues with low-utilization, and/or other request to analyze the issue and queue data.

The system can analyze a generative response and cause display of a group modification interface including at least a portion of the generative response. The group modification interface can include one or more changes to the current queue structure, including the addition of new queues, removal of existing queues and/or modification or existing queues by modifying and/or creating queue definitions.

The system can generate a prompt that includes a request to analyze data extracted from the multiple sets of issue tickets and/or current queues and identify frequently used filter settings for organizing issue tickets associated with a particular project. This type of recommendation criteria may be used to identify queue definitions that are used by some members of the project and suggest that other members, not using currently using these queue definitions, configure their instance of the graphical user interface to include these queue definitions.

In some cases, a particular user or set of users may have queue definitions that result in them having higher efficiency or better metrics in one or more areas (e.g., in progressing and/or resolving issue tickets more quickly) as compared to other users of the system. For example, a particular user's queue definitions may decrease their time to respond to new issue tickets as compared to other user's, increase the number of issue tickets that user resolves compared to other users, decrease that user's time to resolution of an issue ticket, and so on. Accordingly, the system may generate prompts that identify these types of queue definitions, that lead to increased productivity, and can use the generative response to suggest these queue definitions to other users of the system.

In some cases, the prompt can include a request to analyze the summaries and identify issue tickets having common issues. The prompt can include an issue summary for each issue ticket of the multiple sets of issue tickets. The prompt can be configured to identify similar issue types, and generate a queue definition that groups issues having similar issue types into an issue group displayed in the graphical user interface. In some cases, the prompt can be configured to identify queues and the corresponding queue definitions that are not being utilized by users of the system. For example, the prompt can include a request to analyze the data extracted from the multiple sets of issue tickets and identify a queue definitions corresponding to a less utilized issue ticket groups (e.g., issue ticket groups/queues that have a usage metric below a defined criteria). This may allow the system to generate a recommendation to remove these queue definitions and corresponding issue ticket groups.

In some cases, a modification to the one or more of the queue definitions causes the system to change in an order of display of one or more queues. For example, the system may display queues having issues associated with higher priority arranged higher in a navigation panel. Additionally or alternatively, the system may lock the display order of one or more queues and/or prevent deletion or modification of corresponding queue definitions. The locking of the display order or preventing of modification to specific queue definitions may be managed by an administrative user account based on permission associated with the account.

Embodiments are further related to system and methods for managing issue queues that can be used to organize and track issue tickets managed by an issue tracking system. Issue tickets managed by an issue tracking system may be assigned to a queue based on one or more parameters associated with the issue ticket. For example, each queue managed by the system can be associated with a queue definition that includes one or more defined parameters for determining which issues tickets are displayed in a particular queue. The queues may be used to group issue tickets by a common parameter such an agent assigned to the issue tickets, priority associated with issue tickets, due date for the issue tickets, a type of issue and so on. Typically, a user of the system may assign issues a parameter, such as assigning an agent to work on the issue and/or may assign the issue to a particular queue, which can result in the issue being associated with the queue parameter.

The systems can methods described herein are configured to use issue and queue data to assign one or more unassigned issues to a particular queue/issue group. The system can be configured to use issue and queue data associated with the unassigned issue tickets to generate a prompt for a generative response engine. The system can receive a generative response based on the prompt and use content from the generative response to assign the issue tickets. The prompt can include predetermined prompt text that includes grouping instructions, data extracted from the issue tickets which need to be grouped, and data extracted from issue tickets that have been assigned within the system. The grouping instructions can include a request of how to group the issue tickets based on analyzing data extracted from the unassigned issue tickets and data extracted from the assigned issue tickets. In this regard, the prompt may include information relevant to grouping the unassigned issues tickets, such as which agents the assigned set of issue tickets are associated with, priorities assigned to the assigned set of issue tickets, assigned location of the assigned of issue tickets, workflow data (e.g., current status, activities, service level agreements (SLA) info, state transitions, transaction message data, and/or other event data), and so on.

In some cases, the prompt may identify a set of user accounts, which can include a set of user accounts assigned to a particular project. In these cases, the issue tickets are assigned to the set of users associated with the particular project, and the assigned issue data can also be associated with the particular project. Accordingly, the generative output relates directly to activity occurring within the particular project.

Providing data, within the prompt, extracted from the unassigned tickets and data extracted from the assigned issues can help ensure that assignments, priorities, locations and/or other factors are balanced between agents and already assigned issues for a project. For example, the prompt may include a request to assign the unassigned issues to distribute priorities and SLA response times evenly across agent accounts associated with a project. This may help ensure that issues are meeting SLA metrics. Additionally or alternatively, the prompt may include a request to identify types of issues (e.g., an expertise) associated with one or more particular agents and to categorize the unassigned set of issue into issue types and assign the issue based on matching issue types with an expertise determined for a particular agent account.

The system can receive a generative response from a generative output engine in response to submitting the prompt. The system may analyze the generative response and arrange the issues into multiple groups of issue tickets based on the generative response. For example, the generative response may assign each of the unassigned to a particular agent account. In response to assigning each of the issues, the system may display a field assignment interface indicating the assigned features of each issue. The field assignment interface can include issue tickets from the first set of issue tickets arranged into multiple groups of issue tickets. Each group of issue tickets can be associated with a particular parameter assigned to a respective issue. The field assignment interface can indicate a temporary/suggest assignment of issues prior to the issues being assigned. In some cases, the assignment interface can be configured to allow changes to the proposed issue groups that were created from the generative response. For example, the field assignment interface can include tools (graphical element) for removing issue from assignment, modifying data associated with an issue, and/or performing other actions with respect to an issue.

The foregoing embodiments are not exhaustive of the manners by which automatically generated content can be used in multi-platform computing environments, such as those that include more than one collaboration tool. More generally and broadly, embodiments described herein include systems configured to automatically generate content within environments defined by software platforms. The content can be directly consumed by users of those software platforms or indirectly consumed by users of those software platforms (e.g., formatting of existing content, causing existing systems to perform particular tasks or sequences of tasks, orchestrate complex requests to aggregate information across multiple documents or platforms, and so on) or can integrate two or more software platforms together (e.g., reformatting or recasting user generated content from one platform into a form or format suitable for input to another platform).

### Scalable Network Architecture for Automatic Content Generation

More specifically, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding. In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples). In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input.

For example, the user may engage with a button in a UI that causes a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands-after the user types a slash character, any text input after the slash character can be considered as a command to instruct the underlying system to perform a task.

Regardless of how a software platform user interface is instrumented to receive user input, the user may provide an input that includes a string of text including a natural language request or instruction (e.g., a prompt). The prompt may be provided as input to an input queue including other requests from other users or other software platforms. Once the prompt is popped from the queue, it may be normalized and/or preconditioned by a preconditioning service.

The preconditioning service can, without limitation: append additional context to the user's raw input; may insert the user's raw input into a template prompt selected from a set of prompts; replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### Large Language Models

An example of a generative output engine of a generative output system as described herein may be a large language model (LLM). Generally, an LLM is a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. Generally, an LLM may be trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation may be selected or generated using a number of techniques. In many cases, a continuation of an input prompt may be referred to more generally as “generated text” or “generated output” provided by a generative output engine as described herein.

Generally, many written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation.

In addition, because punctuation and whitespace can serve as a portion of training data, generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt.

For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=′https://example link/123456>project 123456</a>”.

In addition, the LLM may be configured to replace the substring “pending” with a real-time updating token associated with an API call to the project management system. In this manner, the LLM converts a static string within the document management system into richer content that facilitates convenient and automatic cross-linking between software products, which may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilities bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Transformer Architecture

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of different attention mechanisms, including self-attention mechanisms, may be suitable.

In sum, in response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations.

In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### Generative Output Engines & Generative Output Systems

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoint, such as for configuration or for receiving input prompts. The generative output application can be further configured to provide generated text output to one or more subscribers or API clients. Many suitable interfaces can be configured to provide input to and to receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:

```
{
  “prompt” : “Generate five words of placeholder text in the
English language.”,
  “API_KEY: “hx-Y5u4zx3kaF67AzkXK1hC”,
  “user_token”: “PkcLe7Co2G-50AoIVojGJ”
}
```

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:

```
{
  “response” : “Hello world text goes here.”,
  “generation_time_ms” : 2
}
```

In some embodiments, a prompt provided as input to a generative output engine can be engineered from user input. For example, in some cases, a user input can be inserted into an engineered template prompt that itself is stored in a database. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### Prompt Pre-Configuration, Templatizing, & Engineering

As noted above, a prompt received from a user can be preconditioned and/or parsed to extract certain content therefrom. The extracted content can be used to inform selection of a particular engineered prompt template from a database of engineered prompt templates. Once the selected prompt template is selected, the extracted content can be inserted into the template to generate a populated engineered prompt template that, in turn, can be provided as input to a generative output engine as described herein.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance” or “prompt preconditioning software instance”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences. For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on.

For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:

```
{
  “raw_prompt” : summarize the edits to this page made by
my team since I last visited this page”,
  “modified_prompt” : “Generate a summary of each
paragraph tagged with an editId attribute matching editId=1,
editId=51, editId=165, editId-99 within the following HTML-
formatted content: [HTML-formatted content of the page].”
}
```

Similarly, the preconditioning service may utilize a project graph, issue graph, or other data structure that is generated using edges or relationships between system object that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:

{
“snippet123_table_from_tasks” : “The table should be
formatted as a three-column table with multiple rows. The leftmost
column should be titled ‘Title’ and the corresponding content of each
row of this column should be the title attribute of a task. The middle
column should be titled ‘Created Date’ and the corresponding
content of each row of this column should be the creation date of the
task. The rightmost column should be titled ‘Status’ and the
corresponding content of each row of this column should be the
status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:

{
“modified_prompt” : “Find all tasks assigned to User 1234
dating from Jan 01, 2023 - Jan 14, 2023 (inclusive). Create a table
in which each found task corresponds to a respective row of that
table. The table should be formatted as a markdown table, in plain
text, with three columns. The leftmost column should be titled ‘Title’
and the corresponding content of each row of this column should be
the title attribute of a respective task. The middle column should be
titled ‘Created Date’ and the corresponding content of each row of
this column should be the creation date of the respective task. The
rightmost column should be titled ‘Status’ and the corresponding
content of each row of this column should be the status attribute of
the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents. In yet other examples, staging of requests may be useful for other purposes.

### Authentication & Authorization

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each page or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url.”

In yet other examples, a prompt engineering service may be configured to classify a user input into one of a number of classes of request. Different classes of request may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein.

More generally, as noted above, a generative output engine may be a portion of a larger network and communications architecture as described herein. This network can include input queues, prompt constructors, engine selection logical elements, request routing appliances, authentication handlers and so on.

### Collaboration Platforms Integrated with Generative Output Systems

In particular, embodiments described herein are focused to leveraging generative output engines to produce content in a software platform used for collaboration between multiple users, such as documentation tools, issue tracking systems, project management systems, information technology service management systems, ticketing systems, repository systems, telecommunications systems, messaging systems, and the like, each of which may define different environments in which content can be generated by users of those systems. These types of platforms may be generally referred to herein as “collaboration platforms” or “content collaboration platforms.”

In one example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine, as described herein, in order to automatically generate structured or unstructured content within environments defined by those systems.

In some implementations, a content collaboration system may include a documentation system, also referred to herein as a documentation platform, which can leverage a generative output engine to provide a generative answer interface to provide synthesized or generated responses leveraging content items hosted by the system. The documentation system may also leverage a generative output engine to provide, without limitation: summarize individual documents; summarize portions of documents; summarize multiple selected documents; generate document templates; generate document section templates; generate suggestions for cross-links to other documents or platforms; generate suggestions for adding detail or improving conciseness for particular document sections; and so on. As described with respect to examples provided herein, a documentation system can store user-generated content in electronic documents or electronic pages, also referred to herein simply as documents or pages. The documents or pages may include a variety of user-generated content including text, images, video and links to content provided by other platforms. The documentation system may also save user interaction events including user edit action, content viewing actions, commenting, content sharing, and other user interactions. The document content in addition to select user interaction events may be indexed and searchable by the system. In some examples, the documentation system may organize documents or pages into a document space, which defines a hierarchical relationship between the pages and documents and also defines a permissions profile or scheme for the documents or pages of the space.

In some implementations, a content collaboration system may include an issue tracking system or task management system (also referred to herein as issue tracking platforms or issue management platforms). The issue tracking system may also leverage a generative output engine to provide a generative answer interface to provide synthesized or generated responses leveraging content items (e.g., issues or tasks) hosted by the system. The issue tracking system may also leverage a generative output engine to provide, without limitation: summarize issues; summarize portions of issues or fields of issues; summarize multiple selected issues, tasks, or events; generate issue templates; and so on. As described with respect to examples provided herein, an issue tracking system can manage various issues or tasks that are processed in accordance with an automated workflow. The workflow may define a series of states that the issue or task must traverse before being completed. The system may also track user interaction events, issue state transitions, and other events that occur over the lifecycle of the issue, which may be indexed and searchable by the system.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multi-tenant software platform.

For simplicity of description, the multi-tenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform-multi-tenant or otherwise—as described herein are not collocated, and communicate over a large area and/or wide area network by leveraging one or more networking protocols, but this is not required of all implementations.

A frontend of a software platform, also referred to as a frontend or client application, may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multi-tenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multi-tenant software and, in particular, by a provider of suites of multi-tenant software platforms, each platform being configured for a different particular purpose. Herein, providers of systems or suites of multi-tenant software platforms are referred to as “multiplatform service providers.”

In general, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multi-tenant issue tracking system, a multi-tenant code repository service, and a multi-tenant documentation service. In this example, an organization that is a customer/client of the service provider may be a tenant of each of the issue tracking system or platform, a code repository system or platform (also referred to as a source-code management system or platform), and/or a documentation system or platform.

As with preceding examples, the organization can create and/or purchase user accounts for its employees, so that certain selected employees have access to one or more of issue tracking functionality, documentation functionality, and code repository functionality.

In this example and others, it may be possible to leverage multiple collaboration platforms to advance individual projects or goals. For example, for a single software development project, a software development team may use (1) a code repository to store project code, executables, and/or static assets, (2) a documentation platform to maintain documentation related to the software development project, (3) an issue tracking platform to track assignment and progression of work, and (4) a messaging service or platform to exchange information directly between team members. However, as organizations grow, as project teams become larger, and/or as software platforms mature and add features or adjust user interaction paradigms over time, using multiple software platforms can become inefficient for both individuals and organizations. Further, as described herein, it can be difficult to locate content or answer queries in a multiplatform system having diverse content and data structures used to provide the various content items. As described herein, a generative answer interface may be adapted to access multi-platform content and provide generative responses that bridge various content item types and platform structures.

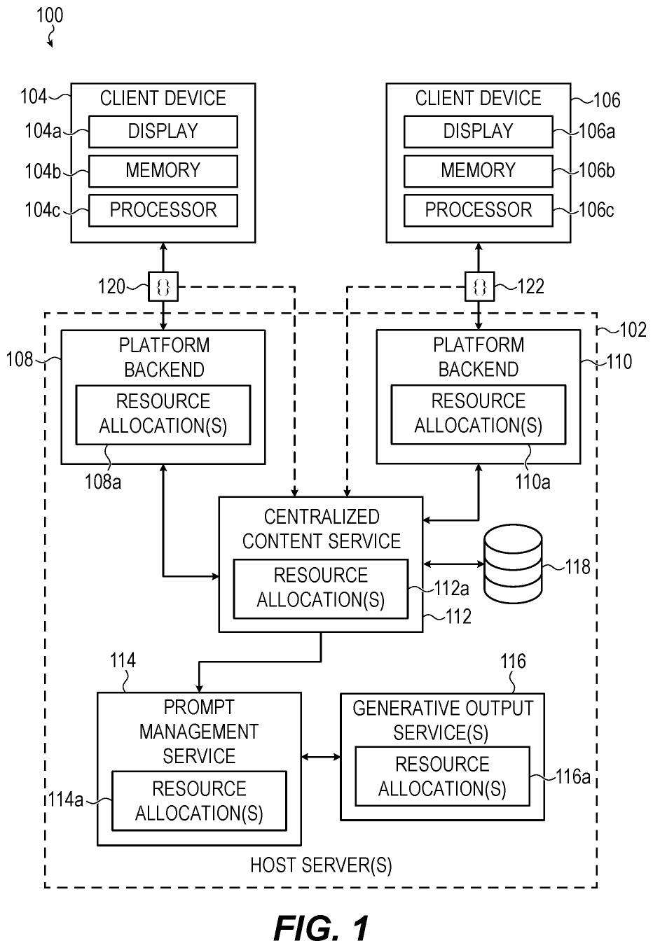

These foregoing and other embodiments are discussed below with reference to FIGS. 1-19. The detailed description given herein with respect to these figures is for explanation only and should not be construed as limiting.

### User Input Resulting in Generative Output

FIG. 1 depicts a simplified diagram of a system, such as described herein that can include and/or may receive input from a generative output engine as described herein. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location. The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples include ITSM systems, chat platforms, messaging platforms, and the like. These backends can be communicably coupled to a generative output engine that can be leveraged to provide unique intelligent functionality to each respective backend. For example, the generative output engine can be configured to receive user prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system as well.

A user of the client devices may trigger production of generative output in a number of suitable ways. One example is shown in FIG. 1. In particular, in this embodiment, each of the software platforms can share a common feature, such as a common centralized editor rendered in a frame of the frontend user interfaces of both platforms.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each communicably couple to a centralized content service 112. The centralized content service may be a search interface, generative content service or, in some cases, a centralized editing service which may also referred to more simply as an “editor” or an “editor service.”

In implementations in which the centralized content service 112 is a search interface or generative content service, the service 112 may be instantiated or implemented in response to a user input provided to a frontend application in communication with one of the platform backends 108, 110. The service 112 may be configured to leverage authenticated user sessions between multiple platforms in order to access content and provide aggregated or composite results to the user. The service 112 may be instantiated as a plugin to the respective frontend application, may be integrated with the frontend application or, in some implementations, may be instantiated as a separate and distinct service or application instance.

In implementations in which this centralized content service 112 is an editing service, the centralized content service 112 may be referred to as a centralized content editing frame service 112. The centralized content editing frame service 112 can be configured to cause rendering of a frame within respective frontends of each of the first platform backend 108 and the second platform backend 110. In this manner, and as a result of this construction, each of the first platform and the second platform present a consistent user content editing experience.

More specifically, the centralized content editing frame service 112 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized content service 112 that can be called by each respective frontend whenever it is required to present the user of that respective frontend with an interface to edit text.

For example, the documentation platform's frontend may call upon the centralized content service 112 to render, or assist with rendering, a user input interface element to receive user text input in a generative interface of a documentation platform. Similarly, the issue tracking platform's frontend may call upon the centralized content service 112 to render, or assist with rendering, a user input interface element to receive user text input or other input in a generative interface. In these examples, the centralized content service 112 can parse text input provided by users of the documentation platform frontend and/or the issue tracking platform backend, monitoring for command and control keywords, phrases, trigger characters, and so on. In many cases, for example, the centralized content service 112 can implement a slash command service that can be used by a user of either platform frontend to issue commands to the backend of the other system. As described herein, the centralized content service 112 may cause display of a generative answer interface having input regions and controls that can be used to receive user input and provide commands to the system.

In one example, the user of the documentation platform frontend can input a slash command to the content editing frame, rendered in the documentation platform frontend supported by the centralized content service 112, in order to type a prompt including an instruction to create a new issue or a set of new issues in the issue tracking platform. Similarly, the user of the issue tracking platform can leverage slash command syntax, enabled by the centralized content service 112, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; the content editing elements can include and/or may be implemented to include many features, which may vary from embodiment to embodiment. For simplicity of description the embodiments that follow reference a centralized content service 112 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized content service 112 can be extended to include additional features and functionality-such as a user input field, selectable control, a slash command processor, or other user interface element-which, in turn, can automatically be leveraged by any further platform that incorporates a generative interface, and/or otherwise integrates with the centralized content service 112 itself. In this example, commands or input facilitated by the generative service can be used to receive prompt instructions from users of either frontend. These prompts can be provided as input to a prompt engineering/prompt preconditioning service (such as the prompt management service 114) that, in turn, provides a modified user prompt as input to a generative engine service 116.

The generative output engine service may be hosted over the host servers 102 or, in other cases, may be a software instance instantiated over separate hardware. In some cases, the generative engine service may be a third-party service that serves an API interface to which one or more of the host services and/or preconditioning service can communicably couple.

The generative output engine can be configured as described above to provide any suitable output, in any suitable form or format. Examples include content to be added to user-generated content, API request bodies, replacing user-generated content, and so on.

In addition, a centralized content service 112 can be configured to provide suggested prompts to a user as the user types. For example, as a user begins typing a slash command in a frontend of some platform that has integrated with a centralized content service 112 as described herein, the centralized content service 112 can monitor the user's typing to provide one or more suggestions of prompts, commands, or controls (herein, simply “preconfigured prompts”) that may be useful to the particular user providing the text input. The suggested preconfigured prompts may be retrieved from a database 118. In some cases, each of the preconfigured prompts can include fields that can be replaced with user-specific content, whether generated in respect of the user's input or generated in respect of the user's identity and session.

In some embodiments, the centralized content service 112 can be configured to suggest one or more prompts that can be provided as input to a generative output engine as described herein to perform a useful task, such as summarizing content rendered within the centralized content service 112, reformatting content rendered within the centralized content service 112, inserting cross-links within the centralized content service 112, and so on.

The ordering of the suggestion list and/or the content of the suggestion list may vary from user to user, user role to user role, and embodiment to embodiment. For example, when interacting with a documentation system, a user having a role of “developer” may be presented with prompts, content, or functionality associated with tasks related to an issue tracking system and/or a code repository system. Alternatively, when interacting with the same documentation system, a user having a role of “human resources professional” may be presented with prompts, content, or functionality associated with manipulating or summarizing information presented in a directory system or a benefits system, instead of the issue tracking system or the code repository system.

More generally, in some embodiments described herein, a centralized content service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized content service 112 as described herein can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein refence systems and methods for sharing user interface elements rendered by a centralized content service 112 and features thereof (such as input fields or a slash command processor), between different software platforms in an authenticated and secure manner. For simplicity of description, the embodiments that follow reference a configuration in which a centralized content editing frame service is configured to implement user input fields, selectable controls, a slash command processor, or other user interface elements.

More specifically, the first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized content service 112. Information can be transacted by and between the frontend, the first platform backend 108 and the centralized content service 112 in any suitable manner or form or format. In many embodiments, as noted above, the client device 104 and in particular the first platform frontend can be configured to send an authentication token 120 along with each request transmitted to any of the first platform backend 108 or the centralized content service 112 or the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client devices resources 106a-106c, respectively.

As with many embodiments described herein, the second platform frontend can be configured to communicate with the second platform backend 110 and/or the centralized content service 112. Information can be transacted by and between the frontend, the second platform backend 110 and the centralized content service 112 in any suitable manner or form or format. In many embodiments, as noted above, the client device 106 and in particular the second platform frontend can be configured to send an authentication token 122 along with each request transmitted to any of the second platform backend 110 or the centralized content editing frame service 112.

As a result of these constructions, the centralized content service 112 can provide uniform feature sets to users of either the client device 104 or the client device 106. For example, the centralized content service 112 can implement a user input field, selectable controls, a slash command processor, or other user interface element to receive prompt input and/or preconfigured prompt selection provided by a user of the client device 104 to the first platform and/or to receive input provided by a different user of the client device 106 to the second platform.

As noted above, the centralized content service 112 ensures that common features, such as user input interpretation, slash command handling, or other input techniques are available to frontends of different platforms. One such class of features provided by the centralized content service 112 invokes output of a generative output engine of a service such as the generative engine service 116.

For example, as noted above, the generative engine service 116 can be used to generate content, supplement content, and/or generate API requests or API request bodies that cause one or both of the first platform backend 108 or the second platform backend 110 to perform a task. In some cases, an API request generated at least in part by the generative engine service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized content service 112. The user input may include a prompt to be continued by the generative engine service 116.

The prompt management service 114 can be configured to modify the user input, to supplement the user input, select a prompt from a database (e.g., the database 118) based on the user input, insert the user input into a template prompt, replace words within the user input, preform searches of databases (such as user graphs, team graphs, and so on) of either the first platform backend 108 or the second platform backend 110, change grammar or spelling of the user input, change a language of the user input, and so on. The prompt management service 114 may also be referred to herein as herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative engine service 116 as an input. More particularly, the prompt management service 114 is configured to structure an API request to the generative engine service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative engine service 116 should process the request; an output format or encryption identifier; and so on. One example of such an API request is a POST request to a Restful API endpoint served by the generative engine service 116. In other cases, the prompt management service 114 may transmit data and/or communicate data to the generative engine service 116 in another manner (e.g., referencing a text file at a shared file location, the text file including a prompt, referencing a prompt identifier, referencing a callback that can serve a prompt to the generative engine service 116, initiating a stream comprising a prompt, referencing an index in a queue including multiple prompts, and so on; many configurations are possible).

In response to receiving a modified prompt as input, the generative engine service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative engine service 116 can be provided to the centralized content service 112 to return to a suitable backend application, to in turn return to or perform a task for the benefit of a client device such as the client device 104 or the client device 106. More particularly, it may be appreciate that although FIG. 1 is illustrated with only the prompt management service 114 communicably coupled to the generative engine service 116, this is merely one example and that in other cases the generative engine service 116 can be communicably coupled to any of the client device 106, the client device 104, the first platform backend 108, the second platform backend 110, the centralized content service 112, or the prompt management service 114.

In some cases, output of the generative engine service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative engine service 116 to the frontend (e.g., rendered on the client device 104, as one example) so that a user of the client device 104 can approve the content before it is prepended to the document. In another example, output of the generative engine service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative engine service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may be a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative engine service 116.

Suggestions rendered in a UI can also include and/or may be associated with one or more configurable or “templatized prompts” that are engineered with one or more fields that can be populated with data or information before being provided as input to an LLM. An example of a templatized prompt may be “summarize all tasks assigned to ${user} with a due date in the next 2 days.” In this example, the token/field/variable ${user} can be replaced with a user identifier corresponding to the user currently operating a client device.

This insertion of an unambiguous user identifier can be performed by the client device, the platform backend, the centralized content editing frame service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user 123 with a due date in the next 2 days” can be retrieved from a database or other memory, and provided as input to the generative engine service 116.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “${user prompt}. Provide output of any table in the form of a tab delimited table formatted according to the markdown specification.” In this example, the variable ${user prompt} may be replaced with the user prompt such that the entire prompt received by the generative engine service 116 can include the user prompt and the example sentence describing how a table should be formatted.

In yet other embodiments, a suggestion may be generated by the generative engine service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative engine service 116 may generate a set of JSON objects that, when received by the Kanban platform, are rendered as a set of cards in a Kanban board, each card including a different title and description corresponding to different tasks that may be associated with steps for creating a new iced cream flavor. In this manner, the user can quickly be presented with an example set of initial tasks for a new project.

In yet other examples, suggestions can be configured to select or modify prompts that cause the generative engine service 116 to interact with multiple systems. For example, a suggestion in a documentation system may be to create a new document content section that summarizes a history of agent interactions in an ITSM system. In some cases, the generative engine service 116 can be called more than once and/or it may be configured to generate its own follow-up prompts or prompt templates which can be populated with appropriate information and re-submitted to the generative engine service 116 to obtain further generative output. More simply, in some embodiments, generative output may be recursive, iterative, or otherwise multi-step in some embodiments.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a.

Similarly, the second platform backend 110 may be instantiated over the resource allocations 110a (including processors, memory, storage, network communications systems, and so on). Likewise, the centralized content service 112 is supported by a processor and memory and network connection (and/or database connections) collectively represented for simplicity as the resource allocations 112a.

The prompt management service 114 can be supported by its own resources including processors, memory, network connections, displays (optionally), and the like represented in the figure as the resource allocations 114a.

In many cases, the generative engine service 116 may be an external system, instantiated over external and/or third-party hardware which may include processors, network connections, memory, databases, and the like. In some embodiments, the generative engine service 116 may be instantiated over physical hardware associated with the host servers 102. Regardless of the physical location at which (and/or the physical hardware over which) the generative engine service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative engine service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

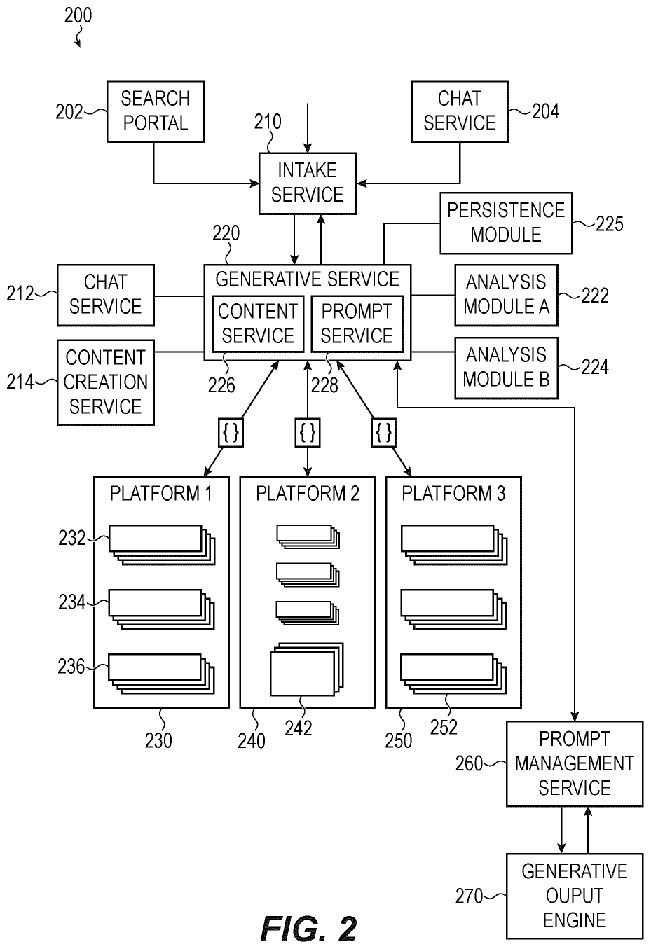

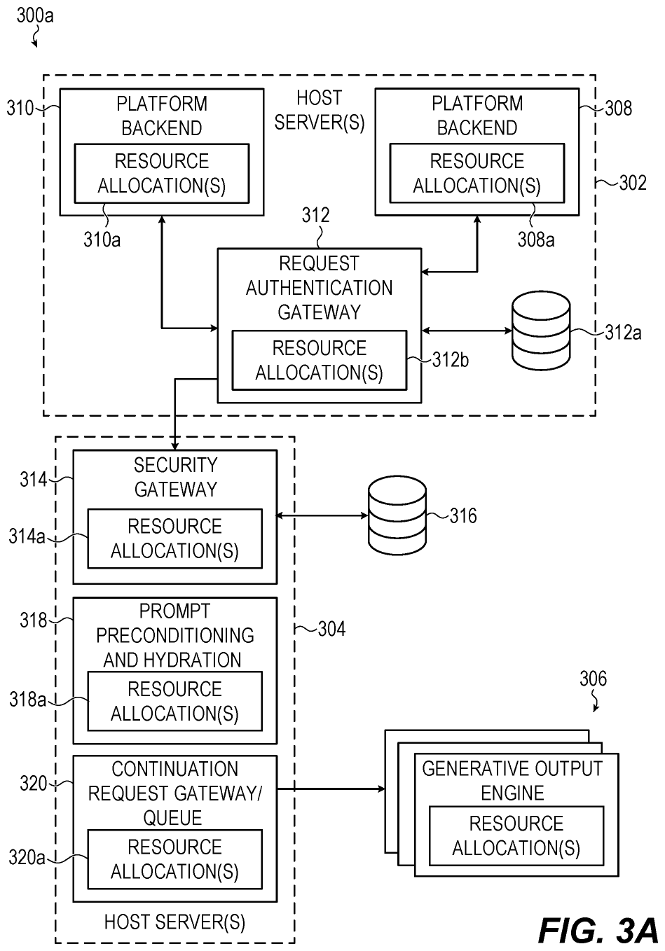

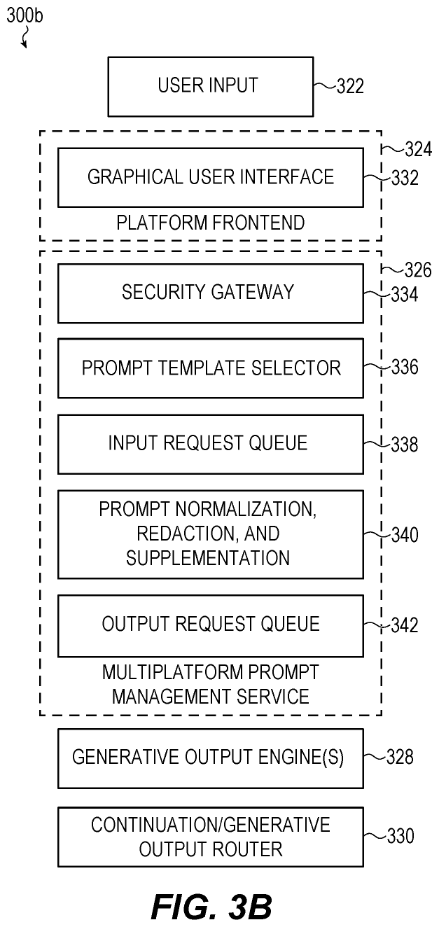

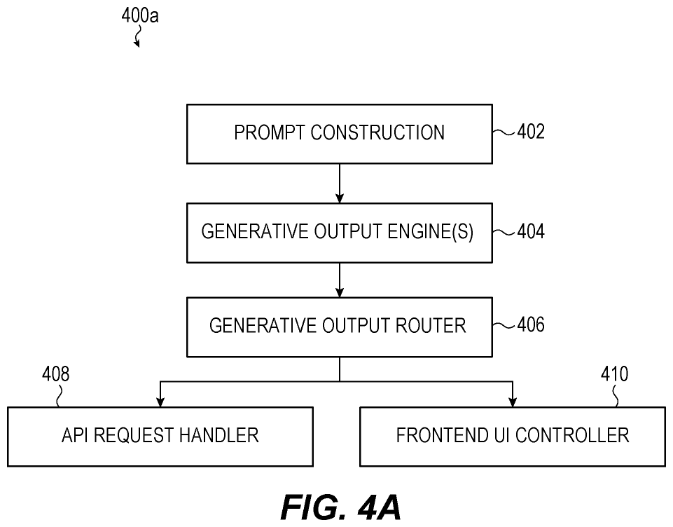

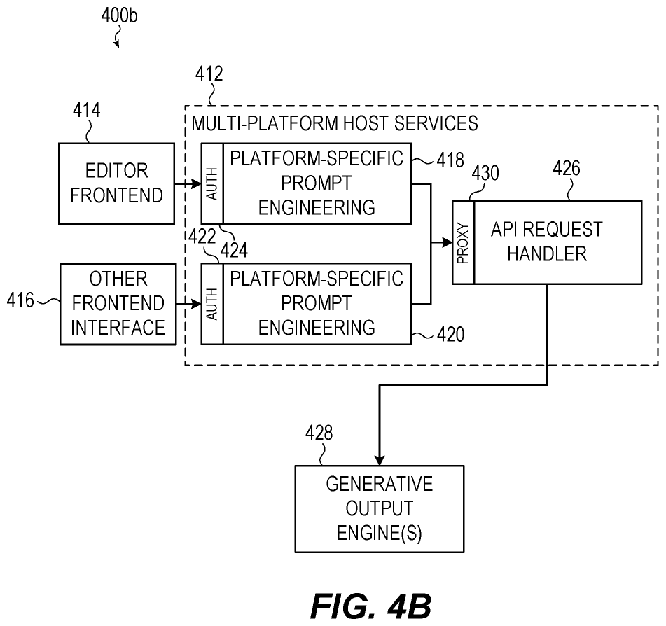

FIG. 2 depicts an example system 200 for providing generative content. The system 200 can be used to operate a generative interface, as described with respect to user interface that can submit prompts to a generative output engine and receive generative responses as described herein. The system 200 can also leverage elements and system components described above in FIG. 1 and below with respect to FIGS. 3A-4B.

The system 200 of FIG. 2 may be used as a general or universal generative content service that is able to draw from a wide range of curated content such as content from an issue tracking platform in the form of a prompt including issue platform data and provide a generative response to the prompt. In some instances, the system 200 may also be directed to provide more specific assistance directed to issue creation, issue management and issue resolution by coordinating generative content and actions with a corresponding issue tracking platform. The system 200 may be similarly adapted for a range of other platform specific or use-case specific scenarios by allowing the system to leverage content from a wide range of designated content, which may be curated or adapted to provide specific services and resources. In the following example, various services or modules are depicted as distinct elements for purposes of demonstration. However, in any particular implementation, elements may be combined or integrated together to provide the same or similar services or operations, as described herein.

In the example of FIG. 2, the system 200 includes an intake service 210, which services as the gateway or portal for a variety of sources of user input and/or system generated input. In accordance with many of the examples provided herein, the intake service 210 may be linked or operate a generative interface, which is configured to receive platform generated inputs (e.g., prompt including issue tracking platform data) and other user input. Additionally or alternatively, the intake service 210 may receive input from a variety of other sources including, for example a search portal 202 and a chat service 204. The search portal may include a document or content search interface element that is incorporated into a graphical user interface or may be a dedicated search interface portal that is configured to provide search results in addition to the generative responses that the system 200 is configured to produce. The chat service 204 may include a chat-based interface that is incorporated into another graphical user interface or platform frontend or, alternatively, may be a dedicated chat-based platform. Other services that may leverage the system 200 using the intake service 210 include an issue tracking system intake portal, a company directory, a user homepage or other similar interfaces. Independent of the platform or specific interface, a range of external services or frontends may leverage the system 200 by either accessing the intake service 210 via an application programming interface or through a direct call to the intake service 210.

As shown in FIG. 2, the intake service 210 may include or be coupled to a generative service 220, which may also be referred to herein as an answer service. The generative service 220 is configured to provide generative responses or other generative content that leverages designated content provided by one or more distinct platforms or content providers 230, 240, 240. The generative service 210 may also include services or modules that are able to provide various preprocessing and postprocessing operations described with respect to other system herein.

In this example, the intake service 210 includes or is operably coupled to multiple analysis modules 222, 224, which are adapted to produce or generate different feature sets or analyses of the natural language user input provided by the intake service 210. In one example, the analysis module 222 includes a natural language processor that is adapted to extract key words or phrases from the natural language user input. The analysis modules 222 may perform lemmatization and/or tokenization operations on the natural language user input to obtain the key words or phrases that define the feature set. The analysis module 222 may remove stop words including articles, common verbs, and other words that are predicted to have a minimal impact on the substance of the query. The analysis module 222 may also extract identified tokens or segments of the input that may be subjected to a lemmatization or other service to determine a set of keywords or search terms. In some cases, word embedding operations are also performed, which may result in an expanded feature set that can be used by the system 200. These techniques are provided by way of example and other natural language processing techniques can be used to obtain a set of keywords or search terms. The analysis module 222 may represent the feature set as a list or array of values. The feature set may also be represented as a vector or other multi-dimensional data element. Another analysis module 224 may perform a different analysis to produce a different feature set or representation of the user input. For example, the analysis module 224 may produce a semantic feature set that includes a statement of intent also referred to herein as an “intent.” The intent may be obtained by an intent recognition module which may include or access a machine learning model that is able to classify the user input as being directed to a particular class or type of inquiry. The intent recognition module or model may have been trained using previous input queries and corresponding statements of intent. Using the module or model, the analysis module 224 may determine that the user input is directed to a request for a particular class or style of information. The result of the intent classification may also be used to determine if the user input is a continuation of a string of inquires or is a new or stand-alone inquiry. The result of the analysis module 224 may be stored as a string, a classifier, and/or other value representing the statement of intent.

The generative service 220 may implement a content service 226, which is able take the natural language user input and/or the results of the analysis modules 222, 224 in order to formulate content requests that are served to one or more of the platforms 230, 240, 250. The content service 226 may include or have access to a registry of registered platforms or content providers that are accessible to the generative service 220. The registry may include an address or network location of each of the respective platforms, a list of designated content associated with each platform, and a search classifier that indicates the type or class of input that the platform is configured to use for content retrieval. For example, the search classifier may indicate which type or class of feature set that should be used with each respective platform or content provider. Some platforms are adapted to identify content using a set of key words or phrases and other platforms may be adapted to identify content using statements of intent or other semantic features. The registry may also include additional information including authentication information for platforms that provide secure content, keywords or intent classifying information that can be used for platform selection, and other data that facilitates efficient and accurate content retrieval.

In the example system 200, each of the platforms registered with the content service 226 may be associated with a set of designated content. The designated content may include electronic resources that have been developed or identified as containing accurate and/or verified content. The designated content may also include additional resources including contact information in the form of an electronic contact address (e.g., an email address or chat service user profile, link to user directory entry). The content may be “designated” by providing a particular path or content ID of the content in the registry of the content service 226. In other examples, the content may be designated by the specific platform and identified using a tag or other data attribute that is defined by or used by the respective platform.

The content service 226 formulates respective content requests to be provided to each of the respective platforms 230, 240, 250. Each content request may include a feature set or other analysis of the user input, as generated by a respective analysis module 222, 223. The content request may also include an identifier of the designated content resources provided by each respective platform. For platforms or content providers hosting secure content, the request may also include authentication data including, for example authentication credentials, an authentication token, certificate, or other data element that can be used for authenticating the user. The authentication data may be obtained from a trusted authentication service or passed along by the hosting platform or service. The content service 226 may be provided access on par with or no greater than access granted to the user initiating the request or providing the user input. The content request may also be formulated in accordance with platform specific schema and, in some implementations, is provided as an application programming interface (API) call. The content requests may be paired or grouped in accordance with common or shared search classifiers such that a shared or common feature set may be used for each of the requests in the group. Grouped requests may be executed concurrently, may be executed in series, or in an order determined by content service 226.

In response to a respective content request, each platform or content provider 230, 234, 250 may conduct a search of respective designated content in order to provide results that are passed back to the content service 226. The designated content may be stored in a shared directory, workspace, or other content partition or group. The designated content may also be distributed across a platform or content provider. In the illustrated example, a first platform 230 may include multiple groups of designated content 232, 234, 236, which may be searched in response to a single request or the request may include a particular set of designated content 232 implicitly excluding other designated content 234, 236. As second platform 240 may include a different class or type of designated content 242, which may be stored as platform-specific objects or content items 242. The third platform 250 includes respective content 252, which may be distinct from other content provided by the platform 250.

As discussed previously, the designated content may be selected based on a predicted veracity or vetting conducted by platform operators. In general, the designated content includes text content also referred to herein as textual content. The designated content may also include structured data including non-textual content including, multimedia content, issue or ticket objects, or platform-specific content. As used herein, the terms “structured content” may be used to refer to non-text content that has been formatted or is stored in accordance with a predefined schema or format. The system 200 may be configured to access and analyze some structured content but other structured content may be considered proprietary or unavailable for system access. For such structured content, the system 200 may pass along a link or reference to the structured content and omit more detailed analysis of the content.

In response to a series or set of content requests, each platform served with a request may produce a set of results, which may include content items, extracted text, aggregated search results or other forms of content corresponding to the feature sets provided in each respective request. The results returned by all of the respective platforms or content providers may be aggregated by the generative service 220. The aggregated results may be processed to extract top-scoring or top-ranking results, which may be used to formulate a prompt using the prompt service 228. In one example, the aggregated results are processed by the service 220 to produce an aggregated set of text snippet portions. The service 220 may, for example identify text blocks in each content item or in the aggregated search results and may extract respective text snippet portions that include a least an extraction threshold number of sentences or phrases. For example, the first two sentences of each text block (e.g., paragraph, section, or other grouping of text) may be extracted as a text snipped portion. In other examples, the first three, four, five or six sentences or phrases are extracted from each respective text block. In some cases, the extraction threshold number of sentences is scaled for each text block such that an approximate percentage or ratio of text is extracted from each text block. In other cases, a natural language processing technique is used to identify topic and supporting sentences, which are extracted as text snippet portions. Other natural language processing techniques may eliminate text that is predicted to be contextual, redundant, or non-essential to the text block and remaining text is designated as the respective text snippet portion.

The text snippet portions that have been aggregated by the service 220 may be evaluated with respect to the natural language user input or a representative thereof. For example, each text snippet portion may be subjected to an embedding operation and/or generate a multi-dimensional vector representation of the text. An example embedding operation may add synonyms and predicted corresponding words to words or phrases of the respective text snippet. Additionally, the text snippets may be represented as a vector or other multi-dimensional data element allowing for comparison to a similarly vectorized or processed representation of the natural language user input. For example, a representative vector may be constructed using a word vectorization service that maps words or phrases into a vector of numbers or other characters. A comparison of each vector or other representation may be performed with respect to the user input to determine a degree of correlation or similarity. In one example implementation, a cosine similarity or other similar comparison is performed between respective vectors and a score or value is determined for each pairing. The evaluated snippets may be ranked or sorted by degree of correlation and a subset of snippets may be selected for use in constructing a prompt. In some cases, a threshold score or other degree of correlation is used to select the subset of snippets. In other cases, a threshold number of top scoring results are selected. In other examples, the top-scoring results that provide a threshold number of characters or aggregated snippet size are selected.

The selected or subset of text snippet portions may then be used by the prompt service 228 to construct a prompt that is designed to provoke a relevant and useful generative response from the generative output engine. The prompt service 228 may combine the subset of text snippet portions, context data, at least a portion of the user input, and predetermined prompt text (also referred to as predetermined query prompt text, template prompt text, or simply prompt text) in order to generate or complete the prompt that will be transmitted to the generative output engine 240. The predetermined prompt text may include one of a number of predetermined phrases that provide instructions to the generative output engine 270 including, without limitation, formatting instructions regarding a preferred length of the response, instructions regarding the tone of the response, instructions regarding the format of the response, instructions regarding prohibited words or phrases to be included in the response, context information that may be specific to the tenant or to the platform, and other predetermined instructions. In some cases, the predetermined prompt text includes a set of example input-output data pairs that may be used to provide example formatting, tone, and style of the expected generative response. In some cases, the predetermined prompt text includes special instructions to help prevent hallucinations in the response or other potential inaccuracies. The predetermined prompt text may also be pre-populated with exemplary content extracted from the platform's content item representing an ideal or reference output, which may reflect a style and tone of the tenant or content hosted on the platform.

In some implementations, the generative service 220 may also obtain or extract context data that is used to improve or further customize the prompt for a particular user, current session, or use history. In one example, the generative service 220 may obtain a user profile associated with an authenticated user operating the frontend that produced the user input. The user profile may include information about the user's role, job title, or content permissions classification, which may indicate the type of content that the user is likely to consume or produce. The role classification may be used to construct specific prompt language that is intended to tailor the generative response to the particular user. For example, a user having a role or job title associated with a technical position, the generative service 220 may add text like “provide an answer understandable to a level 1 engineer.” Similarly, for a user having a non-technical role or job title, the generative service 220 may add text to the prompt like, “provide an answer understandable to person without a technical background.” Additionally or alternatively, other context data may be obtained, which may be used to generate specific text designed to prompt a particular level of detail or tone of the generative response. Other context data includes content items that are currently or recently open in the current session, user event logs or other logs that indicate content that has been read or produced by the authenticated user, organizational information that indicates the authenticated user's supervisors and/or reporting employees and current role, and other similar context data. In some cases, a personalized query log is referenced, which includes the user's past queries or search history and an indication of successful (or non-responsive) results may be used as context data. Based on prior search results, the generative service 220 may further supplement to include language that improved past results or omit language that produced non-responsive or otherwise unsatisfactory results.

In some implementations, the generative service 220 may generate block-specific tags or text that is associated with each block of text inserted into the prompt. The tag may be string of numbers and/or letters and may be used to identify the content item from which the block of text or segment of text was extracted. The tag may be an unassociated string of characters that does not inherently indicate a source of the text but can be used by the system, via a registry or some other reference object, to identify the source of the text. In other cases, the tag may include at least a portion of the content identifier, name of the content item, or other characters from which the source of the text can be directly inferred without a registry or reference object. In either configuration, the prompt may include predetermined prompt text that includes instructions for maintaining a record of tags which are used to generate the generative response. Accordingly, the generative service 220 may include a corresponding set of tags in the generative response that indicate which text blocks or snippets of text were used to generate the body of the generative response. This second set or corresponding set of tags may be used by the generative service 220 or other aspect of the system, to generate links, selectable icons, or other graphical objects that are presented to the user. Selection of the generated objects may cause a redirection of the graphical user interface to the respective content item, whether on the same platform or on a different platform. By using a tagging technique, the user may easily select a generated link in order to review the source material or to perform more extensive research into the subject matter of the generative response. If permitted by the generative output engine 270, reference to the content items (e.g., a URL or other addressable location) may be passed to the generative output engine 270 using the prompt and the prompt may include instructions to maintain or preserve the reference to the content items, which can be used to generate the links displayed in the interface with the generative response.

In accordance with other examples described herein, the prompt generated by the prompt service 228 may be communicated to the generative output engine 270 via the prompt management service 260 or prompt gateway. The prompt management service 260 may manage requests or input from multiple generative services in order to provide a single or shared gateway access to the generative output engine 270. In implementations in which the generative output engine 270 is an external service, the prompt may be communicated to the external generative output engine 270 using an application programming interface (API) call. In some cases, the prompt is provided to the generative output engine 270 using a JSON file format or other schema recognized by the generative output engine 270. If the generative output engine 270 is an integrated service, other techniques may be used to communicate the prompt to the generative output engine 270 as provided by the architecture of the platform including passing a reference or pointer to the prompt, writing the prompt to a designated location, or other similar internal data transfer technique. As described throughout herein, the generative output engine 270 may include a large language model or other predictive engine that is adapted to produce or synthesize content in response to a given prompt. The generative response is unique to the prompt and different prompts, containing different prompt text, will result in a different generative response.

In response to the prompt, the generative output engine 270 sends a generative response to the generative service 220. The generative service 220 or a related service may perform post processing on the generative response including validation of the response, filtering operations to remove prohibited or non-preferred terms, eliminate potentially inaccurate phrases or terms, or perform other post-processing operations. As discussed above, the generative service 220 may also process any tags or similar items returned in the generative response that indicate the source of content that was used for the generative response. The generative service 220 or a related service may generate links, icons, or other selectable objects to be rendered/displayed in the generative answer interface. Subsequent to any post-processing operations, the generative response, or portions thereof, are communicated to the frontend application for display in the generative answer interface. In some implementations, the generative service 220 may also receive express feedback provided via the interface regarding the suitability or accuracy of the results. The generative service 220 may also provide feedback that results from object selections, dwell time on the generative response, subsequent queries, and other user interaction events that may signal positive or negative feedback, which may be used to train intent recognition modules or other aspects of the system 200 to improve the accuracy and performance of subsequent responses.

In the present example the generative response and/or a postprocessed version of the generative response is passed back to the intake service 210, which may cause display of at least a portion of the generative response in the generative interface or other respective interface. In the example where the input is received via the chat service 204, the generative response may be displayed in a reply or message of the chat interface. Similarly, in the example in which the input was received from a search portal 202, the results may be displayed in a response region or other designated portion of the corresponding search interface. In the example in which the user input is provided to a generative answer interface or generative interface, the response is displayed in a corresponding region of that interface.

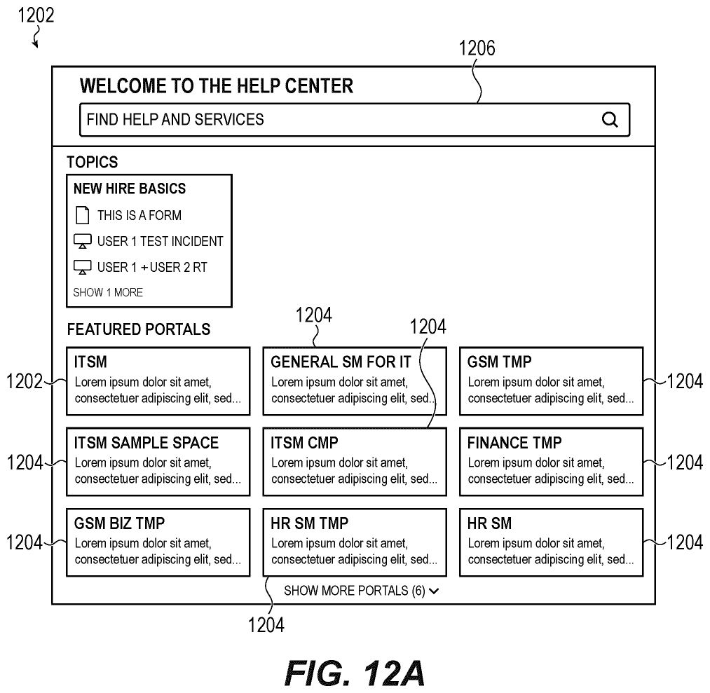

The generative service 220 may also provide or suggest additional actions or link to additional services in response to the generative response. For example, as shown in FIG. 2, the generative service 220 may provide links or an interface to a chat service 212 or to other content creation services 214. The chat service 212 may be used to direct the user to a human operator, chatbot, or other additional resources that may be relevant to the generative response and/or user input. The generative service 220 may also direct the user to external content creation services 214, which may include a documentation service, project management service or issue tracking service. As described in more detail below with respect to FIGS. 11-13, the service may link to an issue-creation form or issue intake portal flow in accordance with the generative response and/or user input. Selectable graphical objects or other interface elements may be displayed or rendered in the generative interface for providing access to these and other selected services.

In one example, the generative service 220 may be configured to generate a link to an issue-creation form based on a set of issues identified in a content request provided by the content service 226. For example, in an implementation in which platform 250 corresponds with an issue tracking platform, the designated content 252 may correspond to a set of issues or tickets managed by the issue tracking platform. The designated issues may correspond to a tenant, a site, at team or other entity. The designated issues may correspond to a time period, an assignee or team, or some other attribute of the issue objects. The issue tracking platform 250 and/or the generative service 220 may also be configured to identify one or more form identifiers which are associated with respective issue-creation forms that were used to generate one or more of the respective issues. For example, as described in more detail below with respect to FIGS. 11-13, an issue may be generated using an issue-creation form that has been selected in accordance with a portal intake workflow. The issue-creation form may have a unique or distinct set of fields and selectable options used to create a specific type of issue adapted to handle a particular class of technical problem or task. The issue tracking system may store or link a form identifier used to create each issue that is generated in accordance with the portal intake workflow. Thus, for issues or issue content that is identified in response to a content request, a corresponding issue-creation form may be selected (using the form identifiers), a link to which may be provided in the generative interface. In response to a user selection of the form link, the graphical user interface may be transitioned to an issue-creation interface displaying the respective issue-creation form. The user may provide data to the issue-creation form in order to create a new issue that is tailored to address an inquiry or issue raised in the natural language user input. In some implementations, a portion of the generative response produced by the generative output engine 270 or the generative service may be used to pre-populate at least a portion of the issue-creation form. For example, a problem statement or description of the issue may be generated by the generative output engine 270 using extracted content and/or portions of the natural language user input, as described herein. The generative service may also cause portions of the issue-creation form to be prepopulated with issue content or other content received in response to one or more content requests.

The generative service 220 or a related service may receive feedback or user validation from user accounts that are identified as having a subject matter expertise related to the generative response. The service or system may, in response to receiving a positive feedback from an account flagged as having appropriate subject matter expertise (e.g., associated subject matter expertise has a threshold similarity to the subject matter of the generative response), the service or system may designate the generative response as verified or endorsed. In some cases, a graphical object corresponding to the verification or endorsement is displayed with the generative response in the corresponding interface. In some cases, verified or endorsed content is cached or saved and used for future responses or for use in subsequent prompts as an example input output pair or as an exemplary response.

In some instances, the generative service 220 may include instructions to provide a confidence metric, such as a confidence interval or confidence score, with any generative response. The confidence metric may indicate an estimated confidence in the accuracy or relevancy of the generative response. In response, the generative output engine 270, may provide the corresponding confidence metric along with the generative output. If the provided confidence metric falls below a threshold or fails to satisfy a confidence criteria, the generative service 220 may not cause the generative response to be displayed in the generative interface. In one example, a generative response having a confidence interval of less than 50% is not displayed. In some cases, a generative response having a confidence interval of less than 60% is not displayed. In some cases, a generative response having a confidence interval of less than 70% is not displayed. In some cases, a generative response having a confidence interval of less than 80% is not displayed. In some cases, the display of the response is suppressed or otherwise not displayed. In some cases, a message indicating that an answer or response is currently not available or other similar message may be displayed in the generative answer interface.

The system 200 may also include a persistence module 225 that can be used to store data from a particular session or series of sessions with a user. The persistence module 225 may store, for example, recent or selected previously utilized elements of the system 200 including previous user input, previous generative responses, previous content retrieved in response to content requests, and other elements generated in a previous or recent interaction with the system. The previous data elements may be stored as an event log or user interaction log and may be arranged chronologically or by topic. In order to preserve user privacy and/or content confidentiality, the memory or cache of the persistence module 225 may either be partitioned by user or cleared when a session is predicted to be completed.

FIGS. 3A-3B depict system diagrams and network/communication architectures that may support a system as described herein. Referring to FIG. 3A, the system 300a includes a first set of host servers 302 associated with one or more software platform backends. These software platform backends can be communicably coupled to a second set of host servers 304 purpose configured to process requests and responses to and from one or more generative output engines 306.

Specifically, the first set of host servers 302 (which, as described above can include processors, memory, storage, network communications, and any other suitable physical hardware cooperating to instantiate software) can allocate certain resources to instantiate a first and second platform backend, such as a first platform backend 308 and a second platform backend 310. Each of these respective backends can be instantiated by cooperation of processing and memory resources associated to each respective backend. As illustrated, such dedicated resources are identified as the resource allocations 308a and the resource allocations 310a.

Each of these platform backends can be communicably coupled to an authentication gateway 312 configured to verify, by querying a permissions table, directory service, or other authentication system (represented by the database 312a) whether a particular request for generative output from a particular user is authorized. Specifically, the second platform backend 310 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 312 can deny the request for insufficient permissions. This example is merely one and is not intended to be limiting; many possible authorization and authentication operations can be performed by the authentication gateway 312. The authentication gateway 312 may be supported by physical hardware resources, such as a processor and memory, represented by the resource allocations 312b.

Once the authentication gateway 312 determines that a request from a user of either platform is authorized to access data or resources implicated in service that request, the request may be passed to a security gateway 314, which may be a software instance supported by physical hardware identified in FIG. 3A as the resource allocations 314a. The security gateway 314 may be configured to determine whether the request itself conforms to one or more policies or rules (data and/or executable representations of which may be stored in a database 316) established by the organization. For example, the organization may prohibit executing prompts for offensive content, value-incompatible content, personally identifying information, health information, trade secret information, unreleased product information, secret project information, and the like. In other cases, a request may be denied by the security gateway 314 if the prompt requests beyond a threshold quantity of data.

Once a particular user-initiated prompt has been sufficiently authorized and cleared against organization-specific generative output rules, the request/prompt can be passed to a preconditioning and hydration service 318 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 318 can be a software instance supported by physical hardware represented by the resource allocations 318a. In some implementations, the hydration service 318 may also be used to rehydrate personally identifiable information (PII) or other potentially sensitive data that has been extracted from a request or data exchange in the system.

One a prompt has been modified, replaced, or hydrated by the preconditioning and hydration service 318, it may be passed to an output gateway 320 (also referred to as a continuation gateway or an output queue). The output gateway 320 may be responsible for enqueuing and/or ordering different requests from different users or different software platforms based on priority, time order, or other metrics. The output gateway 320 can also serve to meter requests to the generative output engines 306.

FIG. 3B depicts a functional system diagram of the system 300a depicted in FIG. 3A. In particular, the system 300b is configured to operate as a multiplatform prompt management service supporting and ordering requests from multiple users across multiple platforms. In particular, a user input 322 may be received at a platform frontend 324. The platform frontend 324 passes the input to a prompt management service 326 that formalizes a prompt suitable for input to a generative output engine 328, which in turn can provide its output to an output router 330 that may direct generative output to a suitable destination. For example, the output router 330 may execute API requests generated by the generative output engine 328, may submit text responses back to the platform frontend 324, may wrap a text output of the generative output engine 328 in an API request to update a backend of the platform associated with the platform frontend 324, or may perform other operations.

Specifically, the user input 322 (which may be an engagement with a button, typed text input, spoken input, chat box input, and the like) can be provided to a graphical user interface 332 of the platform frontend 324. The graphical user interface 332 can be communicably coupled to a security gateway 334 of the prompt management service 326 that may be configured to determine whether the user input 322 is authorized to execute and/or complies with organization-specific rules.

The security gateway 334 may provide output to a prompt selector 336 which can be configured to select a prompt template from a database of preconfigured prompts, templatized prompts, or engineered templatized prompts. Once the raw user input is transformed into a string prompt, the prompt may be provided as input to a request queue 338 that orders different user request for input from the generative output engine 328. Output of the request queue 338 can be provided as input to a prompt hydrator 340 configured to populate template fields, add context identifiers, supplement the prompt, and perform other normalization operations described herein. In other cases, the prompt hydrator 340 can be configured to segment a single prompt into multiple discrete requests, which may be interdependent or may be independent.

Thereafter, the modified prompt(s) can be provided as input to an output queue at 342 that may serve to meter inputs provided to the generative output engine 328.

These foregoing embodiments depicted in FIGS. 3A-3B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, although many constructions are possible, FIG. 4A depicts a simplified system diagram and data processing pipeline as described herein. The system 400a receives user input and constructs a prompt therefrom at operation 402. After constructing a suitable prompt, and populating template fields, selecting appropriate instructions and examples for an LLM to continue, the modified constructed prompt is provided as input to a generative output engine 404. A continuation from the generative output engine 404 is provided as input to a router 406 configured to classify the output of the generative output engine 404 as being directed to one or more destinations. For example, the router 406 may determine that a particular generative output is an API request that should be executed against a particular API (e.g., such as an API of a system or platform as described herein). In this example, the router 406 may direct the output to an API request handler 408. In another example, the router 406 may determine that the generative output may be suitably directed to a graphical user interface/frontend.

Another example architecture is shown in FIG. 4B, illustrating a system providing prompt management, and in particular multiplatform prompt management as a service. The system 400b is instantiated over cloud resources, which may be provisioned from a pool of resources in one or more locations (e.g., datacenters). In the illustrated embodiment, the provisioned resources are identified as the multi-platform host services 412.

The multi-platform host services 412 can receive input from one or more users in a variety of ways. For example, some users may provide input via an editor region 414 of a frontend, such as described above. Other users may provide input by engaging with other user interface elements 416 unrelated to common or shared features across multiple platforms. Specifically, the second user may provide input to the multi-platform host services 412 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 412 can include multiple software instances or microservices each configured to receive user inputs and/or proposed prompts and configured to provide, as output, an engineered prompt. In many cases, these instances—shown in the figure as the platform-specific prompt engineering services 418, 420—can be configured to wrap proposed prompts within engineered prompts retrieved from a database such as described above.

In many cases, the platform-specific prompt engineering services 418, 420 can each be configured to authenticate requests received from various sources. In other cases, requests from editor regions or other user interface elements of particular frontends can be first received by one or more authenticator instances, such as the authentication instances 422, 424. In other cases, a single centralized authentication service can provide authentication as a service to each request before it is forwarded to the platform-specific prompt engineering services 418, 420.

Once a prompt has been engineered/supplemented by one of the platform-specific prompt engineering services 418, 420, it may be passed to a request queue/API request handler 426 configured to generate an API request directed to a generative output engine 430 including appropriate API tokens and the engineered prompt as a portion of the body of the API request. In some cases, a service proxy 430 can interpose the platform-specific prompt engineering services 418, 420 and the request queue/API request handler 426, so as to further modify or validate prompts prior to wrapping those prompts in an API call to the generative output engine 428 by the request queue/API request handler 426 although this is not required of all embodiments.

These foregoing embodiments depicted in FIGS. 3A-3B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

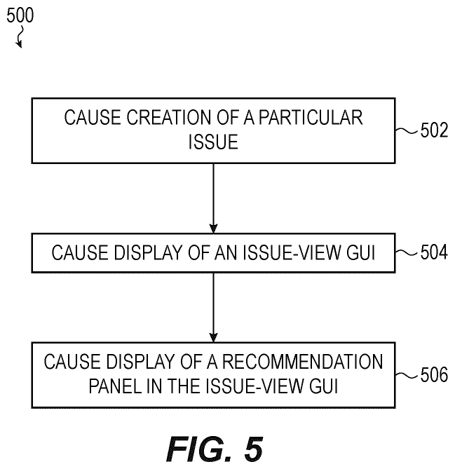

FIG. 5 depicts an example process 500 for generating a recommendation panel for an issue tracking platform. The process can be performed by the systems described herein.

At operation 502, the process 500 includes causing creation of a particular issue at an issue tracking system. A user may use the system to generate issue tickets to assist with a problem or other task that needs to be addressed, as described herein. The issue tickets can be generated using a help desk portal, which may include sub-portals that are defined by a series of interfaces defined in accordance with a project or intake category. In some cases, a particular issue is assigned a request type, which may characterize a type of issue associated with an issue ticket. The request type may be based on query category or other category that was selected as part of the ticket generation process as described herein. For example, a sub-portal may include multiple different query categories corresponding to different categories of issues and in response to a user selecting a particular query category as part of the issue ticket generation process (e.g., using the issue creation workflow described with respect to FIGS. 11-13), the system may associate the particular issue with a request type corresponding to the selected query category.

At operation 504, the process 500 includes causing display of an issue-view GUI, which can include issue data relating to a particular issue. The issue-view GUI can be used by users of the system to manage and processes issue tickets. In particular, the issue-view GUI can be used by an agent user who is responsible for reviewing, working-on or otherwise progressing issues that are submitted by other users (e.g., non-agent or requesting users) of the system. The issue-view GUI can display information about a particular issue including a title of the issue, a summary of the issue (e.g., input by a user creating the issue ticket/request), activity performed on the issue including workflow information, messages, status, priority, SLA, and/or other information relative to the issue, as described herein.

In some cases, an agent user may submit messages to and/or receiving message from a requesting user (e.g., the user that created the issue ticket) via the issue-view GUI. The messages may relate to the issue and include status updates, trouble-shooting steps, and/or other information relevant to solving the particular issue. As messages are exchanged between an agent user and a requesting user, the messages may become part of the issue data. The messages may also be referred to herein as “transaction messages.” The system can generate the issue-view GUI for agents of the system and generates a different GUI for requesting users (e.g., issue tracking portal 1400 described with respect to FIGS. 11-13).

At operation 506, the process 500 includes causing display of a recommendation panel in the issue-view GUI. The recommendation panel may be shown in the issue-view GUI for a particular issue and provide information that is relevant to solving the particular issue. In some cases, the recommendation panel can be generated in response to a request by an agent user to view a particular issue in the issue-view GUI. Additionally, the recommendation panel may be a dynamic object that is updated as changes to the issue occur. For example, content displayed in the recommendation panel can be updated in response to new transaction messages, changes in workflow, changes in status, changes in priority, an SLA and so on.

The recommendation panel may be generated using issue data and include information and/or suggestions for an agent that can be used to progress the corresponding issue. When the system causes a particular issue to initially be displayed in the issue-view GUI the recommendation panel can include a first set of content that is based on current data associated with an issue. As more data is generated for the issue, for example in response to additional transaction messages, changes in workflow, a user performing one or more troubleshooting steps, the system may update the content of the recommendation panel based on the additional issue data.

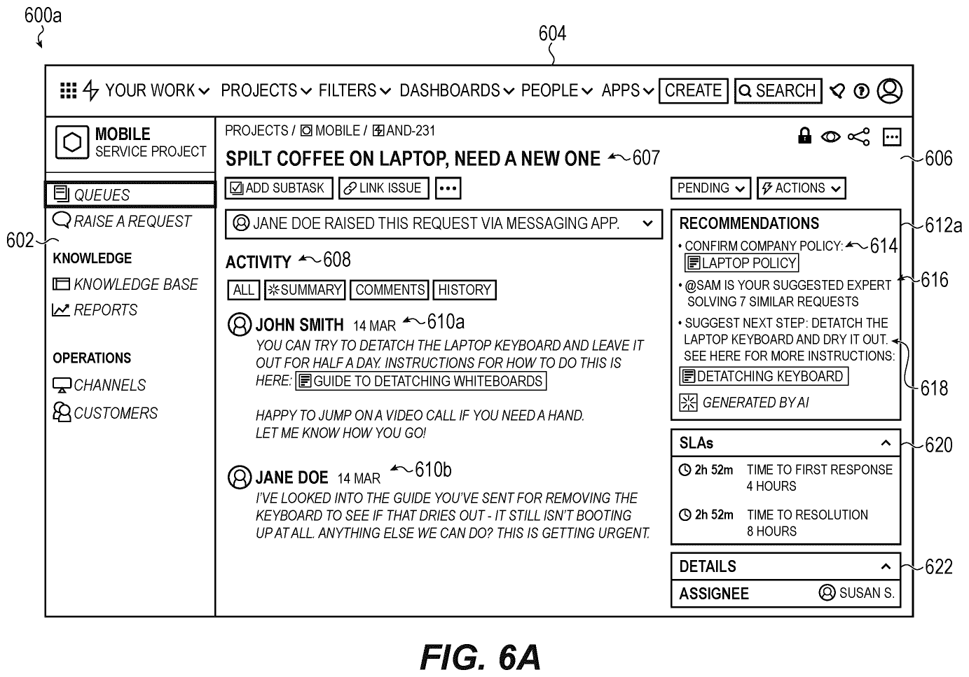

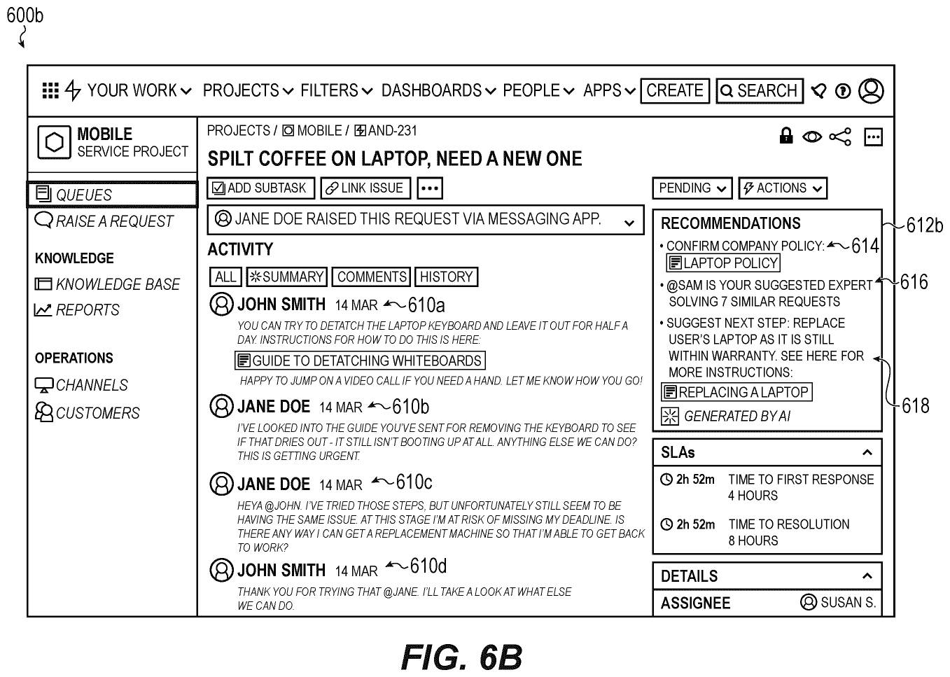

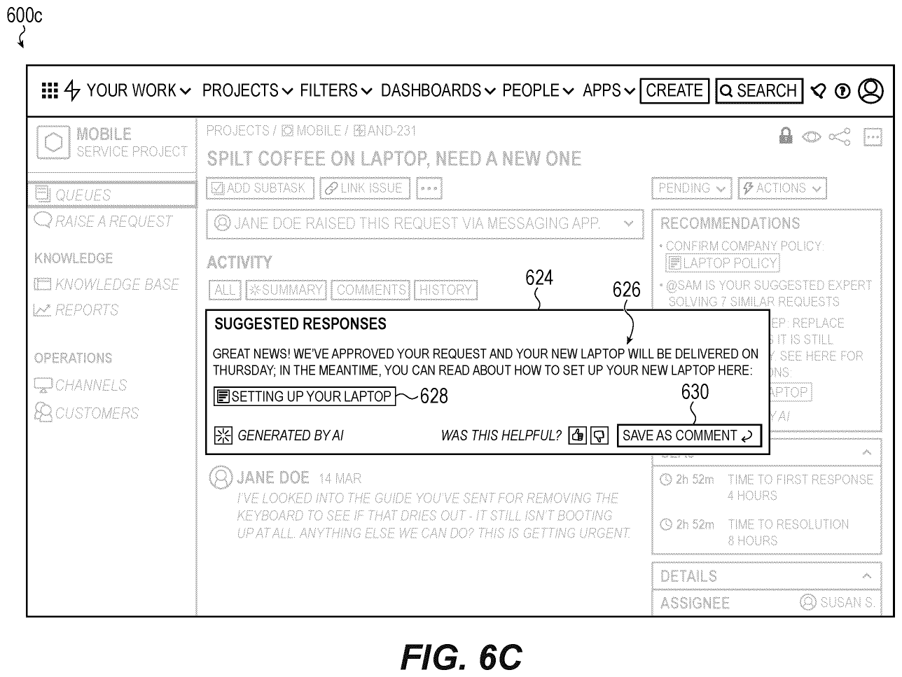

FIG. 6A depicts an example issue-view GUI 600a including a recommendation panel 612. The issue-view GUI 600a can be an example of the issue-view GUIs described herein. In some cases, the issue-view GUI 600a can have various partitions/sections displaying different content. For example, the graphical user interface 600a may include a navigational panel 602, a toolbar 604, and an issue data panel 606.

The navigational panel 602 may include a hierarchical element tree (also referred to herein as a listing of queues, issue groups or issues), which may be associated with particular issues, one or more issue queues, and/or one or mor particular projects, which may be used to manage a set of issues. The hierarchical element tree includes tree elements, which may be selectable to cause display of a corresponding issue or queue. Tree elements may also be referred to herein as selectable elements. Each tree element for the hierarchical element tree may be selectable. In response to a user selection of a respective element of the hierarchical element tree 603, content of the respective issue or queue may be displayed in the issue data panel 606. In some cases, display of the navigational panel 602 may suppressed or hidden using a control provided in the graphical user interface 600a. Additionally or alternatively, the navigational panel 602 may be resized or slid all the way to the side of the graphical user interface in order to hide or suppress display of the navigational panel 602.

The toolbar 604 may provide, to a user, various control options, including but not limited to, set, or configure various restrictions for the issue, queue, and/or project, to view or review issues. The toolbar 604 may also include a search or query space for the user to enter one or more keywords to perform search for issues, queues, projects or content that may be managed by the issue tracking system. The toolbar 604 may also include options for selecting a different project, view recently viewed issues or queues, view people associated with the system or respective content, navigate or launch other applications, or view other aspects of the system. The toolbar 604 may include a create element for initiating the creation of issues in the issue tracking system.

The issue data panel 606 can display issue data related to a particular issue (e.g., selected using the navigation panel 602). The issue data panel 606 can include a title and/or summary 607 of an issue, which may be input by a requesting user as part of creating the particular issue. The issue data panel 606 can include an activity transaction log 608, which may display issue data include transaction messages, an issue summary, a workflow log, automations performed on a particular issue, actions performed at external systems that are related to the particular issue and so on. As shown in FIG. 6A, the transaction log 608 displays a transaction messages 610, which may be messages that are exchanged between the requesting user and an agent user to resolve the particular issue.

The issue data panel 606 can also include a recommendation panel 612a, which can provide information to an agent user that is relevant to resolving the particular issue. In some cases, the recommendation panel can include one or more of a first section 614, which includes selectable link objects; a second section 616 including an identification of a subject matter expert that is identified by the system for the particular issue; and a third section 618 including a suggested action narrative. Information that is displayed in the first section 614, the second section 616 and/or the third section 618 can be generated by the system based in the issue data for the particular issue.

The first section 614 can include one or more selectable link objects which are generated using issue data related to the particular issue. The link objects can include links to content objects that are relevant to the particular issue and may provide information to an agent user viewing the graphical user interface 600a and/or information that may be provided to a requesting user (e.g., via a tracking user interface, a chat, and/or so on). In some cases, the link objects may be obtained by the system extracting issue data from the particular issue and performing a query on a knowledge base system. In these cases, a link object may direct the agent user and/or requesting user to a content object, such as a knowledge base article, managed by a knowledge base system. The content object may provide information on steps or other actions that may be taken to resolve the particular issue.

In some cases, the system performs a semantic analysis of issue data including an analysis of the title, a summary, transaction messages, and/or other data associated with the particular issue and generates a query using the results of the semantic analysis. In other cases, the system may use issue data, the results of the semantic analysis, and/or identified issue data to generate a prompt for a generative output engine. The prompt can include a request to identify relevant content pages for resolving the particular issue, rank a relevance of identified content pages to the particular issue, and so on.

In some cases, the system may identify link object that are relevant to an agent user and separately identify link objects that are relevant to a requesting user. For example, a first user account associated with the agent user may include first account data that characterizes a technical expertise of the agent user. The system may use the first account data to identify and determine knowledge base content (e.g., content pages) that have technical information and/or are otherwise correspond to the technical expertise of the agent user. In some cases, the system may provide a technical expertise of the user and multiple content objects as part of a prompt and request the generative output engine to identify relevant content objects that are based on the technical expertise of the agent user. Additionally or alternatively, a second user account associated with a requesting user can include second account data that characterizes a technical expertise of the requesting user. The system can use the second account data to identify and determine knowledge base content (e.g., content pages) that have technical information and/or are otherwise correspond to the technical expertise requesting user. In some cases, the graphical user interface can indicate whether a link object to a content object is intended for an agent user and/or intended to be provided to a requesting user.

The second section 616 can include an identification of a user account that is determined by the system to be a subject matter expert relevant to the particular issue. The system can be configured to determine a subject matter of the particular issue and using that information to identify a user account that is associated with the determined subject matter. In some cases, agent users (or other users) may be associated with a user account that includes data related to a subject-matter expertise associated with a particular user. The subject matter-expertise data can include an identification of one or more subject matter areas, a number of issues a particular user has been associated with having a particular type of subject matter, and/or any other stored information that relates a particular user account to a subject matter area. The system can use the determined subject matter from a particular issue to identify user accounts that have a corresponding subject matter expertise stored in the account profile/data.

The system can determine the subject matter of the particular issue by analyzing issue data such as a title of the issue, a summary of the issue, a request type associated with the issue, transaction messages of the issue, performing a semantic analysis of issue data, and so on. In some cases, the system may access resolved issues having a same or similar subject matter (e.g., same request type) and evaluate user accounts assigned to each issue. The system may determine a subject matter expert based on a user account that is associated with the highest number of issues having the same or similar subject matter (e.g., same request type). In some cases, the second section 615 can include a link to a user profile of a subject matter expert user.

The third section 618 can include a suggested action narrative, which may be determined by the system generating a prompt from the issue data, submitting the prompt to a generative output engine, and receiving a generative response from the generative output engine. In some case, the prompt includes one or more transaction messages and content extracted from the content object included in the first section 614. For example, the prompt may provide the one or more transaction messages, and/or other issue data in the prompt, information from the content object (e.g., text-based description) and a request to summaries steps to address the issue using the content object. The output from the generative response can include a shortened/summarized version of the content object, which may be used to generate the suggested action narrative. In some cases, the suggested action narrative may include other content such as an identification of the particular issue, a link to a resource with information related to the particular issue and/or other information relative to the particular issue.

In some cases, the transaction messages can include a first message 610a that includes agent generated content 610a. The first message can be received at the issue-view user interface 600a. The transaction messages can include a second message 610b that includes user generated content and is received at an intake portal graphical user interface. In some cases, the transaction messages 610 can include actions performed to resolve the particular issue, and the prompt can include at least a portion of the one or more transaction messages 610. In this regard, the generative response may be based on actions that have already occurred with respect to the particular issue. Additionally or alternatively, the prompt may include other issue data indicating actions performed with respect to the issue such as workflow action, status changes, SLA data, priority, internal and/or external automations associated with the issue, and so on.

In some cases, the prompt may include knowledge base content such as a content object and a request to output a summary or list of steps that can be used to resolve or progress the particular issue. In some cases, the prompt may indicate a technical expertise level of the agent and include instructions to the generative output engine to generate a response that is tailored to the technical expertise of the agent. Additionally or alternatively, the prompt may indicate a technical level of the requesting user and include instructions to the generative output engine to generate a response that is tailored to the technical level of the requesting user.

In some cases, an issue may be associated with a particular SLA 610, which may indicate time-frames or other metrics for addressing the particular issue. The system can be configured to identify an SLA associated with the requesting user and extract part or all of SLA and include all or part of the SLA in the prompt. An SLA can include a set of constraints or rules from processing issues for a particular project, which may include workflows, workflow timing, escalation, or alternative workflow definitions, and/or other processing constraints or rules. These may be stores as an SLA ruleset on the system.

In some cases, extracted issue data or other content that is included in the prompt can be configured to base on permissions for the user accounts (e.g., agent and/or requesting user) associate with the issue ticket. For example, the system may be configured to identify permissions associated with the requesting user and/or agent and include content in the prompt that are consistent/comply with a role or other permissions profile of the user(s). In these cases, the content provided to the generative output engine includes content that the requesting user and/or the agent is authorized to access as defined by their corresponding permission profile associated with each of their user accounts. In cases, where a permission profile for an agent is different than for a requesting user, the system may include information in the prompt that designates specific content that each user is authorized to access. For example, a permissions profile for an agent may provide authorization to access content that is not available to the requesting user. In some cases, the system may exclude this information from the prompt and the corresponding generative response will include information that is consistent with permission profiles of both the agent and the requesting user. In other cases, the system may include information that a requesting user in not authorized to access in the prompt along with a designation of which users/permission profiles are authorized to access this information. Accordingly, the generative response may include information that should only be accessed by the agent and not the requesting user. In response to the designation of the permission profiles in the prompt, the generative response may designate that specific information, content or portions of the prompt are to be accessed by the agent, but not by the requesting user. Accordingly, the system may use these designations to generate the content in the recommendation panel for the agent and indicate which information is consistent with a permissions profiled of a user and/or prevent that information from being shared with or otherwise accessed by the requesting user. Additionally or alternatively, display of the content in the recommendation panel may be suppressed if the content used to generate the response has permissions not consistent with the current user permission profile.

In some cases, the system can be configured to utilize a generative output engine to generate a database query for identifying database resources related to the issue. For example, the database query can be submitted to a knowledgebase system to identify content objects that can be used to progress and/or resolve the particular issue. Generating the knowledge base query can include identifying a set of issues using the issue data from the particular issue and generating a prompt including at least a portion of the first issue data and second issue data extracted from the set of issues. In some cases, the prompt can include a request to generate a knowledge base query for identifying content objects that are relevant to solving the particular issue. The prompt can include a request to generate a structured query using a specific syntax. The system can provide the first prompt to a generative output engine and receive a generative response from the generative output engine. The generative response can include a knowledge base query, which can be formatted according to appropriate syntax of the knowledgebase system. The knowledge base query can be submitted to the knowledge base system. In response to receiving a response to the knowledge base query, the system can include links to one or more content objects that are returned as part of the response from the knowledge base system. The objects links can be included in the recommendation panel 612a, for example, the object links can be included in the first portion 614 of the recommendation panel 612a, as described herein. Additionally or alternatively, the system can use the request type associated with the particular issue to generate a knowledgebase query and/or use keywords extracted from issue data to generate the knowledgebase query.

In some cases, the system can identify the set of issues using the issue data from the particular issue by performing a semantic analysis of at least one of an issue description associated with the particular issue and the one or more transaction messages, and performing a search of issues managed by the issue tracking system using a result of the semantic analysis. The semantic analysis may be performed using machine learning techniques such as latent semantic analysis and/or any other suitable processes.

In some cases, the recommendation panel 612a is displayed in an agent view of the particular issue, and the agent can review and/or approve the content contained in the recommendation panel 612a before some or all of the content is shared with the requesting user. Some or all of the content in the recommendation panel 612a (or information derived therefrom) can be shared in the requesting user, for example in the issue tacking portal. In some cases, the amount and/or type of information shared with the requesting user is based on the user's permissions profile (e.g., role), for example, where the permission profile for the user is consistent with the permissions of the content included in the recommendation panel.

FIG. 6B depicts an updated view of the issue-view graphical user interface 600b including an updated recommendation panel 612b. In some cases, updates to the particular issue may cause the graphical user interface 600b and/or the recommendation panel 612b to be updated. For example, a user modification to the issue data, issue state transitions, automation run in relation to the issue or other event associated with the issue may cause the system to generate an updated prompt for the generative output engine. In some cases, the system may be configured to identify particular events that trigger an updated prompt to be generated and submitted to a generative output engine. For example, the system may generate an updated prompt in response to specific types or content of transaction messages, specific types of workflow events, specific types of automation, SLA data and so on. The updated prompt can include the update issue data. The system can receive an updated generative response and updated the suggested action narrative in response to the updated prompt.

For example, the recommendation panel 612a shown in FIG. 6A may be based on issue data that includes the first transaction message 610c and the second transaction message 610b. At a later time the system may receive additional transaction messages such as transaction messages 610c and 610d as shown in FIG. 6B. The system may generate an updated prompt including all the first, second, third and fourth transaction messages 610, which may result in an updated generative response. The generative response may include a different recommendation, and/or references to different content objects based on the additional transaction messages. The system may update the recommendation panel 612b to include these updates. This can include updating one or more of the selectable link objects (e.g., in the first section 614), the subject matter expert user (e.g., in the second section 616) and the suggested action narrative (e.g., in the third section 618).

FIG. 6C depicts an example issue-view graphical user interface 600c including a recommendation window 624. The recommendation window 624 can be generated by the system using the generative response and include content that can be sent to or otherwise shared by the agent and with the requesting user. In this regard, the system can allow the agent to review and/or modify the content within the recommendation window 624 prior to sending the content to the requesting user.

The recommendation window 624 can include a suggested response 626 that can be provide to the user. The suggested response 626 can be formatted as a message that can be submitted to the transaction messages associated with the issue. The suggested response 626 can be included in the generative response in response to content of the prompt. For example, the system can generate a prompt that includes a request to formulate a communication message to the requesting user based on the suggested next action formulated by the generative output engine. Alternatively, the prompt may include a suggested next action (e.g., from another generative response) and a request to use the suggested next action to formulate a communication message to the requesting user. The communication message may be included in the suggested response. In some cases, the prompt can include a request to generate content for the suggested response 626 and indicate a user expertise and/or technical level or other parameters for generating the content. For example, the prompt may include a request to tailor the content for the suggested response 616 to a non-technical user and/or generate a series of steps that can be sent to the user for addressing the issue.

In some cases, the recommendation window 624 can include an object link 628 or reference to a resource (e.g., content object) that is relevant to the particular issue. For example, the object link may cause a knowledge base content object to be displayed on a client device of the requesting user. The recommendation window 624 can include an element 630 to submit the suggested response 626 to the issue data. In response to selecting the element 630, the system may cause the suggested response 626 and the object link 628 to be posted as part of the transaction messages and may send the content or an alert that the content has been posted to the requesting user.

In some cases, the system allows an agent user to modify or otherwise change the suggested response 626 and/or the link object 628. For example, the agent may modify the text, remove the link object, add additional link objects and/or perform other actions that can be submitted to the issue.

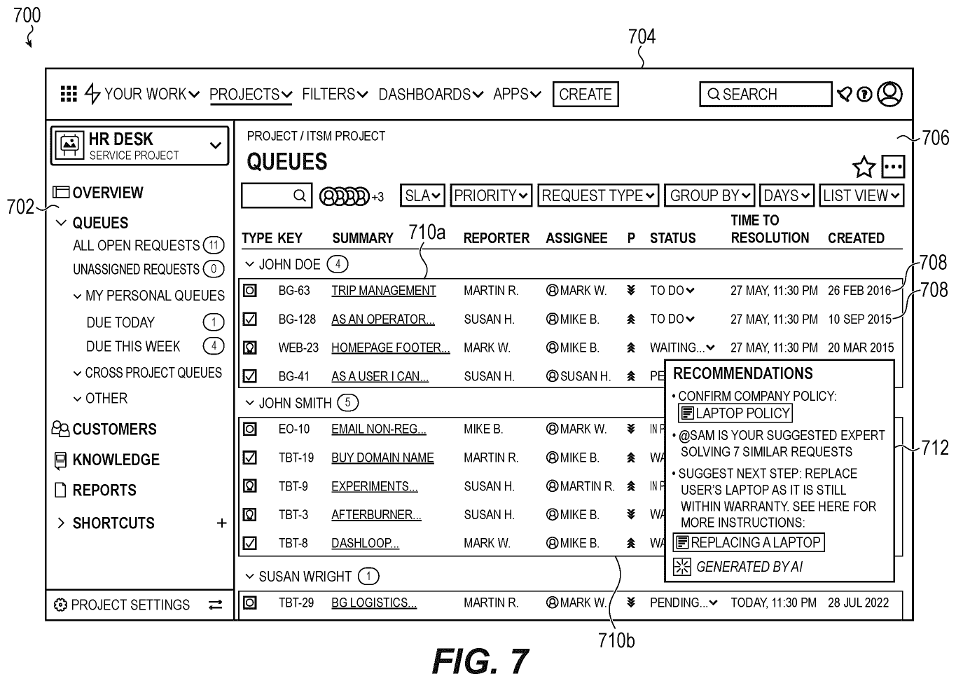

FIG. 7 depicts an example issue-dashboard graphical user interface 700 including a recommendation panel 700. The example issue-dashboard GUI can be an example of the graphical user interfaces described herein. In some cases, the issue-dashboard GUI 700 can have various partitions/sections displaying different content. For example, the graphical user interface 700 may include a navigational panel 702, a toolbar 704, and a dashboard data panel 706. The navigational panel 702 and the toolbar 704 can be examples of the navigation panels and toolbars described herein (e.g., navigation panel 602 and toolbar 604).

The dashboard data panel 706 can include a queue view of issues managed by the issue tracking system. The dashboard panel can display multiple issues 708 arranged according to various queue definitions. For example, the dashboard data panel 706 shown in FIG. 7 provides an example of issues 708 arranged in queues that each correspond to different agent users of the system. For example, a first queue 710a includes a first set of issues assigned to a first agent and a second queue 710b includes a second set of issues assigned to a second agent.

In some cases, the system can be configured to generate and display a recommendation panel 712 in response to an input to a particular issue 708 of the displayed issues. For example, in response to detecting an input (e.g., curser hover, click, touch-input, etc.) to a first issue 708a, the system can cause the recommendation panel 712 to be displayed. The recommendation panel 712 can be an example of the recommendation panels described herein (e.g., recommendation panel 612) and include content such as selectable link objects, link to a subject matter expert user, and/or a suggested action narrative. The system may use issue data for the selected issue (e.g., the first issue 708a) to generate the content for the recommendation panel 712, as described herein. In some cases, the agent can cause the content from the recommendation panel 712 to be submitted/saved to the corresponding issue. Accordingly, the system can be configured to allow an agent to use recommendation panels within the issue-dashboard graphical user interface to respond to various issues without needing to directly view the issue in an issue-view graphical user interface.

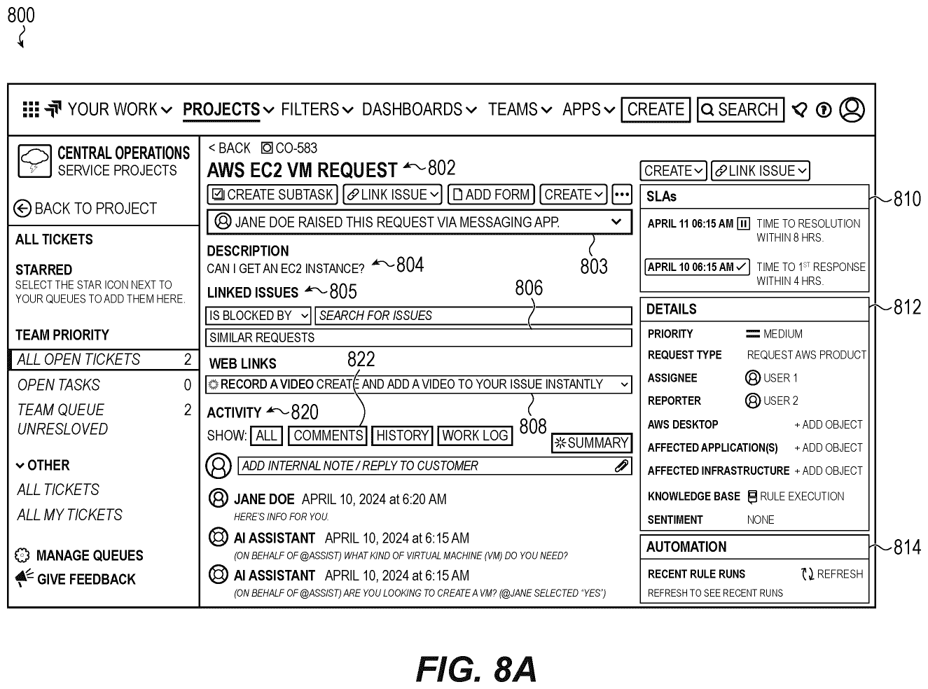

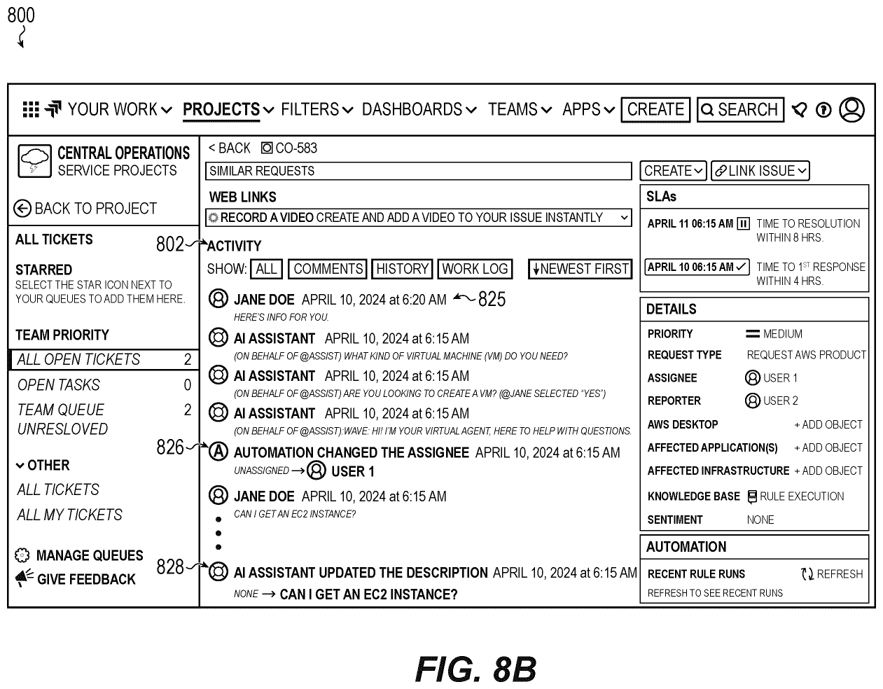

FIG. 8A depicts an example of an issue ticket 800 for issues managed by an issue tracking platform. The issue ticket 800 depicts a visual example of issue data that can be associated with an issue and used to generate the recommendation panels described herein and/or used to generate other content related to the issue.

The issue data associated with an issue ticket 800 can include a title 802, which may be based on a request type that is associated with the issue as part of generating the issue based on the issue creation workflow described herein (e.g., the issue creation workflow described with respect to FIGS. 11-13) and/or a title 802 that is generated by a requesting user. The issue data can include an identification of a requesting user account 803, which may be used to access user data associated with the requesting user. For example, the system may use the user account 803 to access a role of the user, permissions, and so on. The issue data can also include a description of the issue, which is input by the requesting user as part of generating the issue ticket.

In some case, the issue data can include linked issues, which may be related and/or otherwise be linked to the particular issue ticket 800. The issue data can include similar request 806, which may identify similar issues (resolved or pending) such as issues having similar subject matter. For example, the similar requests 806 may include issues that are identified as having similar subject matter using semantic analysis of the issue data associated with the issue ticket 800 and other issues managed by the issue tracking system.

The issue data can include object links 808, which may be identified by an agent, knowledgebase queries performed by the system, and/or using a generative output engine as described herein. In some cases, object links that are identified as part of generating the recommendation panel can be included in the object links data 808.

The issue data can include SLA information, which may define parameters for responding to the issue, performing actions related to the issue, resolving the issue, and so on. The issue data can also include issue details 812, which may include a priority level associated with the issue, request types, an indication of an agent assigned to the issue, and/or other information that may be relevant to responding to the issue. In some cases, the issue data can include an automation summary 814, which can include information about automations or other actions that have been performed by the system.

In some cases, the issue data can include an activity log 820, which can include information about all activity/actions that have been performed in relation to the issue. For example, the activity log 802 can include information related to transaction messages 822 (e.g., “comments”), information related to automations, workflows, user interaction events, issue state transitions, and/or other events that occur over the lifecycle of the issue, which may be indexed and searchable by the system. As shown in FIG. 8A, the transaction log 822 is selected and displays messages that are associated with the issue. An issue can include internal messages, which are messages between agent users in relation to the issue, which may not be viewable to a user that submitted the issue. The issue can also include customer messages which may be messages between an agent (and/or automated messages generated by the system) and a user the submitted the issue. Both the internal and external messages may be captured in transaction message data.

FIG. 8B depicts an example of the issue ticket shown in FIG. 8A including all activity log data 824 that is associated with the issue. For example, the activity log data can include data related to a workflow of the issue. The workflow may define a series of states that the issue or task must traverse before being completed. The activity data log 824 may also track user interaction events, issue state transitions, and other events that occur over the lifecycle of the issue, which may be indexed and searchable by the system.

In some cases, content included in the recommendation panel (e.g., recommendation panels 612 and 712) can be generated using data from similar issues. The similar issues can be identified using issue data 800. The system can be configured to perform a semantic analysis on the issue data 800 and other issues managed by the issue tracking system to identify the similar issues. The semantic analysis may be performed using machine learning techniques such as latent semantic analysis and/or any other suitable processes.

The system may use a prompt to a generative output engine to extract relevant data from the identified similar issues. For example, each issue may include a variety of different data content. In many cases, it can be difficult to determine which data that may be from a similar issue may be relevant to the particular issue and/or what issues may be more similar to the particular issue. Additionally, the particular issues may share different similarities with different portions of the similar issues. For example, each issue that is resolved (or being resolved) using the issue tracking system may include unique data and may have a unique workflow. Accordingly, it may be rare for a current issue to have the same events/actions occur in the same order as a previous/similar issue. Additionally, different users may characterize similar problems differently, for example, by providing different titles, descriptions, characterizing the issue using different request types and so on. Accordingly, depending on a current state of an issue data from multiple different similar issues may be informative in generating a recommendation for progressing the particular issue.

The system may generate a prompt using the identified similar issues and the particular issue data and use a generative output engine to extract actions/events or other data from the similar issues that are relevant to the particular issue. For example, the system may generate a first prompt that includes the set of similar issues to the particular issue identified using semantic analysis of the issue data, and a request to extract actions performed for each issue of the set of similar issues that are relevant to the current issue. In some cases, the system may provide examples of the types of actions to be extracted such a specific types of state transitions, automation that is associated with an issue, priority changes, status transition, content that is associated with a resolution of an issues, and/other specific actions that are contained in the issue data. In some cases, the system may include a request to identify an action that leads to resolution in the prompt.

Additionally or alternatively, the system can configure the first prompt to include issue data from the particular issue and a request to provide a similarity ranking between issues of the set of similar issues and the particular issues.

In some cases, the system can be configured to identify the set of similar issues by identifying issues for the semantic analysis or from the results of the semantic analysis that include a respective date that is associated with a timeframe from the particular issue. For example, the system may pull issue data for the semantic analysis from issues that were opened and/or resolved within a defined duration (e.g., 6 months, 1 year, 2 years, and so on) from the current issue. Accordingly, the systematic analysis can be based on issues that have a defined time relationship to the current issue, which may help identify more recently resolved issues having that are associated with more recent protocols, content, or procedures.

In some cases, the first prompt can include a request to extract issue data including action and result pairs for issues of the set of similar issues, a first generative response can include issue data for issues of the set of similar issues. The action and result pairs may include activity performed on a respective issue and a resulting issue state transition. The action and result pairs may include standard/defined action result pairs for actions that can be performed on an issue managed by the issue tracking platform. The action and result pairs can include examples of defined results that are performed by the issue tracking system in response to a specific type of action.

The system may use the generative response that resulted from the first prompt to generate a second prompt, which may utilize the generative output engine to generate a recommendation for solving the particular issue using the relevant information extracted from the similar issues. For example, the system may generate a second prompt that includes issue data extracted from the particular issue and the summary of actions received as part of the first generative response. The summary of actions is related to the identified similar issues, and therefore, can be provide examples of relevant actions that were performed in the identified similar issues. The second prompt can also include predetermined prompt language associated with a recommendation request. In some cases, the prompt can request the generative output engine to identify activity that has occurred on the current issue and generate a recommendation based on similar activity from the summary of actions. In other cases, the prompt may include a request to identify actions from the summary of actions for the similar issues and determine if those same actions can be applied to the current issues. Additionally or alternatively, the prompt may include a request to rank proposed actions for progressing or resolving the current issue.

In some cases, the second prompt can include a request to identify an action that led to resolution for issues of the set of similar issues and the second generative response includes a set of summaries comprising a respective summary of an action that led to resolution for each of the issues of the set of similar issues. The system can configure the recommendation panel to include the set of summaries. Additionally or alternatively, the recommendation request for the second prompt can include a request to recommend a next action to perform for the particular issues based on the information provided for the set of similar issues, and the system can configure the recommendation panel to include a recommendation for the next action to perform for the particular issue based on the generative response.

In response to receiving the generative response, the system can cause display of a recommendation panel in the issue-view graphical user interface including content generated using the second generative response.

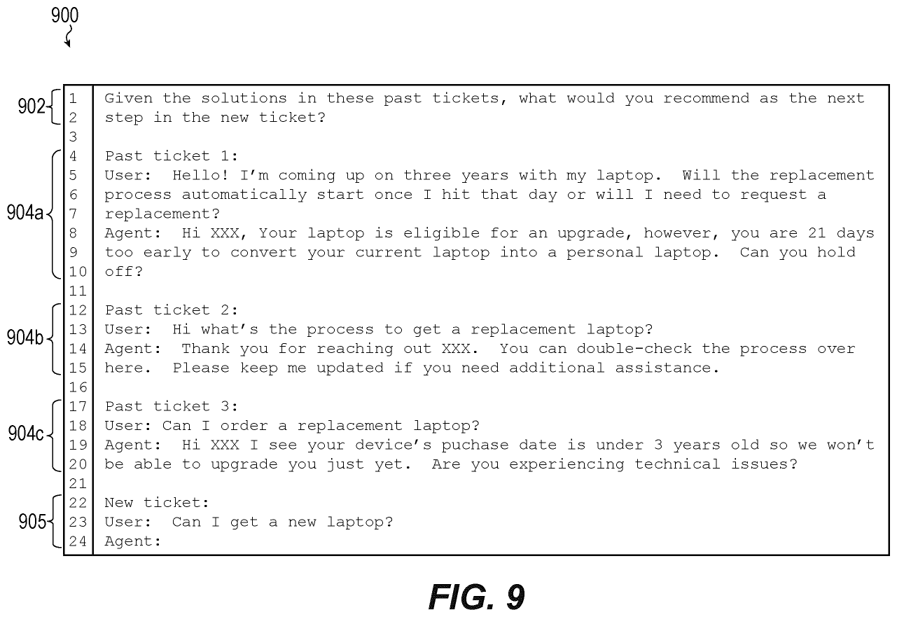

FIG. 9 depicts an example prompt 900 that can be submitted to a generative output engine. The generative prompt 900 can be an example of a prompt that includes issue data extracted from summary of actions 904 received as part of the first generative response and issue data 905 related to a particular issue. The prompt can also include predetermined prompt language 902 associated with a recommendation request. In some cases, the summary of actions 904 can include transaction messages, which may include messages exchanged between an agent and a user that submitted the respective issue. Additionally or alternatively, the summary of actions can include workflow data such as automations performed on each issue, issue state transition, status changes and/or other suitable issue information as described herein.

The predetermined prompt language 902 can include a request to the generative output engine to provide a specific type of response using the summary of actions 904 and the current issue data 905. For example, the prompt language 902 can be a request to suggest a next step based on data from the similar issues (e.g., the summary of actions 904). In some cases, the prompt language 902 may include a request to generate a message to the requesting user and/or generate information for the agent. For example, the prompt language could include an instruction to determine a next step, explain the reasoning to an agent for recommending the next step and/or generate a message that the agent can send to a non-technical user for addressing the issue.

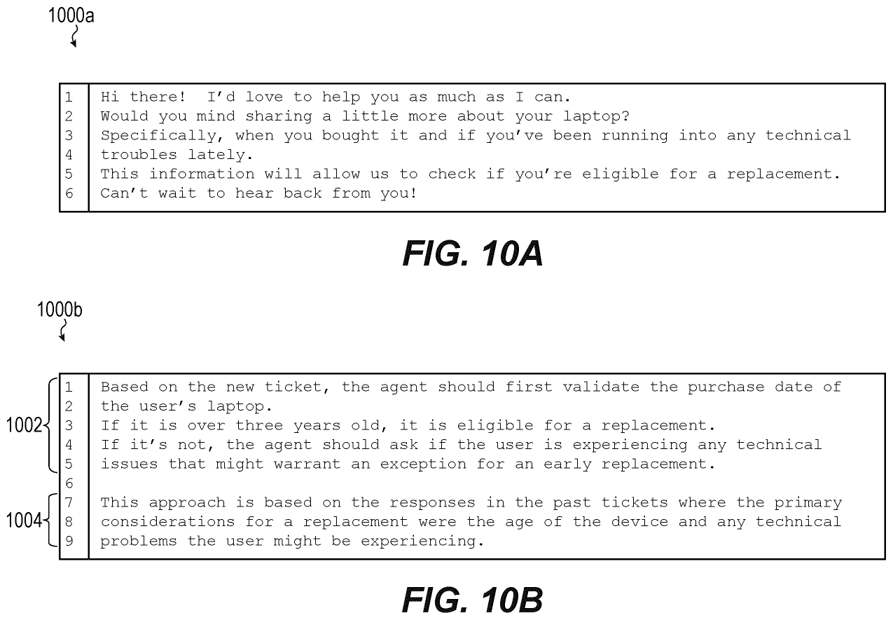

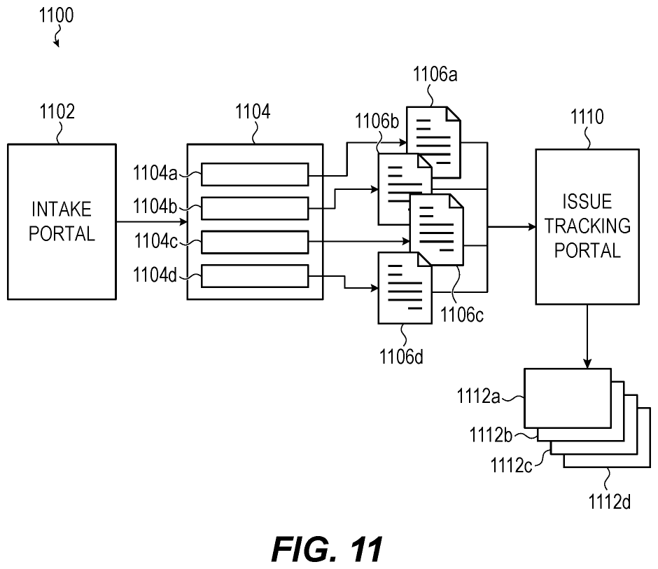

FIG. 10A depicts an example suggested user message 1000a generated using a generative response. For example, the suggested user message 1000a may be in response to the prompt provided to the generative output engine an include instructions, a request for additional information and/or other content that can be sent via the issue tracking system to the requesting user. In some case, the prompt can include example text for adding style or request the generative output engine to phrase the user message 1000a using a specific tone (e.g., “draft a user message having a positive and enthusiastic tone”).

FIG. 10B depicts an example generative response 1000b obtained in response to a prompt submitted to a generative output engine. The generative response 1000b may be a response or portion of a response that is generated for an agent user of the system. For example, the generative response may be generated based on a technical expertise associated with the agent user account and/or instructions provided in the prompt. The generative response 1000b can include a first portion 1002 that explains the next steps that the agent should perform in addressing the issue and a second a second portions 1004 that explains reasons why the next steps were suggested.

In some cases, a generative response, for example based on issue data from similar issued identified using semantic analysis, can be used to generate a user message for display in the intake portal graphical user interface using the received generative response. The user message can include a suggested action narrative and agent information. In some cases, the recommendation panel can include an option to cause the user message to be displayed in the intake portal graphical user interface. Accordingly, in response to an agent selection of the option the user message may be sent to the user via the intake portal graphical user interface.

An example of an issue tracking system and the use of issue-creation forms is described in more detail below with respect to FIGS. 11-13.

FIG. 11 shows an example workflow 1100 for an example issue creation flow using an intake portal or other similar issue reporting software. The example workflow 1100 can be used to cause creation of an issue such as described with reference to FIG. 5. Through the following example, the selection and use of issue-creation forms is shown as it relates to issues managed by an issue tracking platform. With regard to the other examples described herein, stored issues may be associated with form identifier or form ID, which can be used by the systems described herein to generate a form link as part of a generative service or generative interface.

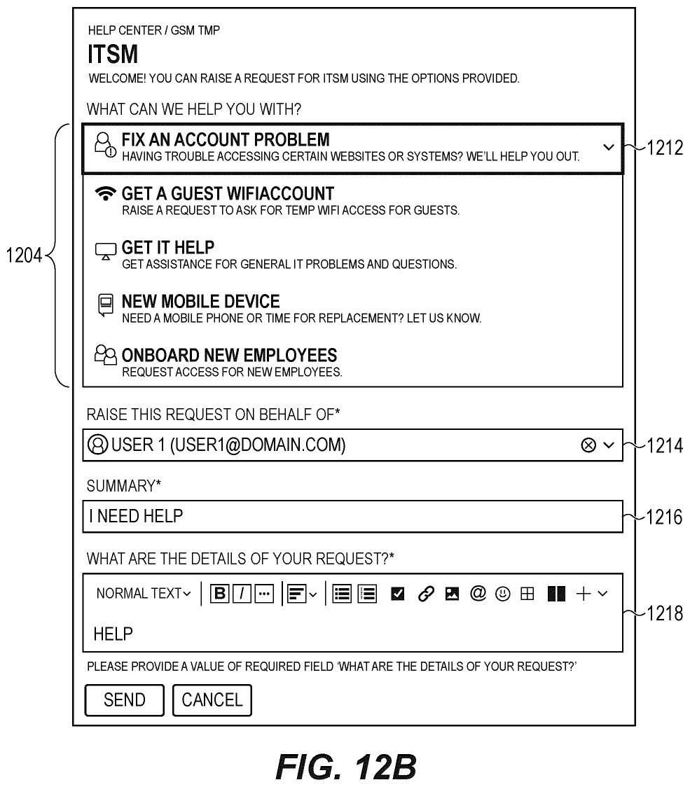

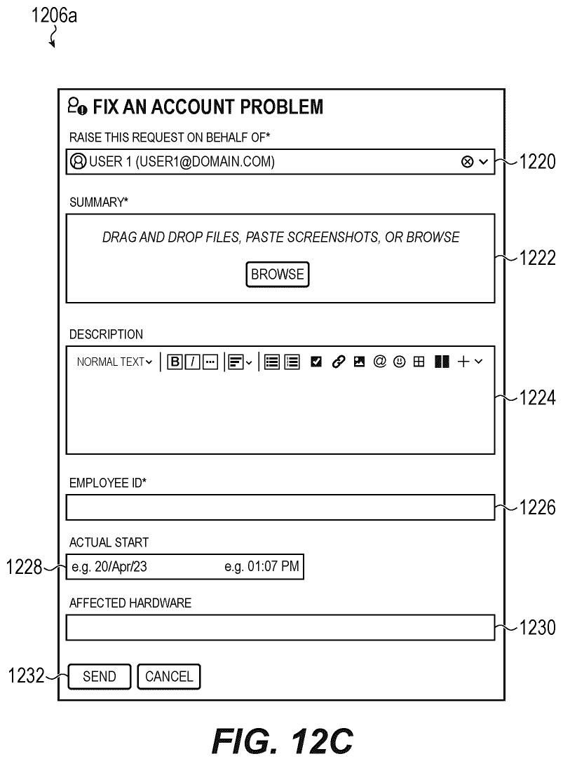

With regard to FIG. 11, a user may use the system 1100 to generate tickets or issues to assist with a problem or other task that needs to be addressed. Following authentication, a user (e.g., a service agent or a customer) may access the help desk portal 1102. An example graphical user interface is presented in FIGS. 12A-12C. As shown in FIG. 12A, a home page of the help desk portal 1102 may include sub-portals, which are defined by a series of interfaces defined in accordance with a project or intake category. Selecting an intake category may cause the portal to route a user to different features of the help desk. For example, the help desk portal 1102 may include an ITSM portal 1202 where a user may seek IT-related assistance. Similarly, the help desk may include portals 1204 for different departments of an enterprise, including human resources, finances, and so on. The help desk portal 1102 may also include a search bar 1206 to facilitate finding of information, such as documents relating to a knowledge base.

Upon selecting a sub-portal, such as the ITSM portal 1202, an interface for raising an issue is presented, as shown in FIG. 12B. The interface may include multiple input items that corresponds to fields, such as a request type field 1212, a requestor field 1214, a summary field 1216, and a description field 1218. Upon selecting the request type field 1212, the user may be presented with a menu of intake categories. This menu of intake categories may correspond with the menu 1104 of FIG. 11A. As shown in FIGS. 11A and 12B, the menu of intake categories allows users to select a request that best fits their needs. For example, “FIX AN ACCOUNT PROBLEM,” “GET A GUEST WIFI ACCOUNT,” “GET IT HELP,” “NEW MOBILE DEVICE,” and “ONBOARD NEW EMPLOYEES” may each correspond to different requests. Each of these requests may correspond to intake interfaces 1104a-d in FIG. 11A.

Upon selection of an intake interface (e.g., 1104a, 1104b, 1104c, or 1104d), a backend application may retrieve a form 1106a, 1106b, 1106c, 1106d that corresponds to the intake interface. Each of these forms may be created by an administrator via a request creator form interface 1108 and may be identified or retrieved using a form identifier or form ID. In some embodiments, each form is unique to the intake interface and includes input items that correspond to field elements from the request item builder, and which is tailored to the user's issue category. An example form (e.g., 1106a) is presented in FIG. 12C.

As shown in FIG. 12C, the form is tailored to relevant information relating to a “FIX AN ACCOUNT PROBLEM” issue. For example, the form may include a user field 1220, a summary field 1222, a description field 1224, a department number field 1226, an actual start 1228, and an affected hardware field 1230. As shown in the figure, certain fields may be required, such as the summary field 1222, the user field 1220, and the department number field 1226. As explained above, each of these fields may be tailored to the particular problem.

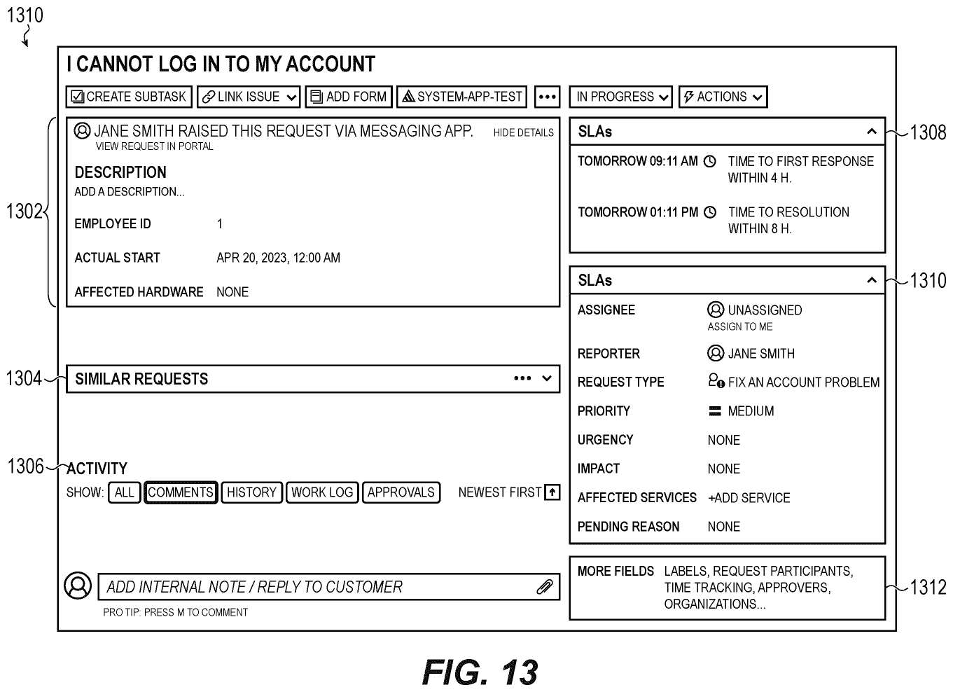

Once a user (e.g., a customer user, a service agent) fills out and submits the form (e.g., via “SEND” button 1232), the service management system may transmit the data to an issue tracking system, which generates an issue item based on the data from the form. As shown in FIG. 11A, a service agent may have access to an issue tracking portal 1110, which may be a graphical user interface of the issue tracking platform. At the issue tracking portal, a user may view the data input into the form from the help desk, view the status of the ticket, view/edit other information, and the like. An example issue tracking portal interface is presented in FIG. 13.

As shown in FIG. 13, the issue tracking portal 1300 may display an issue item and relevant tracking information. For example, the data input in the form 1106a may be displayed in a first display area 1302. In some cases, users (e.g., agents, administrators) may edit these fields as more information is received. In some cases, the intake interfaces may include hidden fields. These hidden fields may be displayed to users in the first display area 1302.

As discussed previously, the issue tracking platform may store or track the issue-creation form that was used to create respective issues or tickets. The issue-creation form that was used to create the issue may be stored as a form identifier or form ID and associated with the issue or ticket in the issue tracking platform. The issue tracking platform or the issue tracking portal 1110 may also gather other data (e.g., from user event logs or databases coupled to the issue tracking system), including similar requests 1304 and activity 1306. In many cases, enterprises use a service-level agreement (SLA), which specifies the process, timelines, and metrics by which services, such as IT, are provided. The issue tracking system may include issue item metric regions, such as regions 1308 and 1310, which may track metrics according to the SLA. For example, upon generating an issue item, the issue tracking system may automatically set a time for reply and completion that may correspond to the SLA. Similarly, region 1310 may include editable field items that may be used to resolve the issue. For example, an issue item may be assigned to particular service agents, the urgency of the request may be set, and the like. The issue tracking portal 1110 may also include other fields 1312 which may be used by service agents to track metrics, add labels, track time, and the like.

The issue tracking platform may process each of the issues or tickets in accordance with a workflow or series of predefined states that the issue must traverse in order to be resolved by the issue tracking platform. An example workflow from the time an issue time is created is presented in FIG. 11B. In some embodiments, at the intake interface builder interface, a workflow can be defined contemporaneously with the intake interface and with the issue item view in an issue tracking platform. When an issue is created 1112, a workflow for resolving the issue is generated (e.g., via a backend application of the service management portal, such as the issue tracking system). As a first step, the issue may be assigned 1114 to a service agent or other users. In some embodiments, the request type and/or other fields from the intake interface may determine the assigning step. For example, a group of users may be assigned to particular intake categories. As another example, a group of users may be assigned to a project where the particular request type can be used. As yet another example, a particular data input to a field (e.g., “AFFECTED HARDWARE”) may determine a user or a group of users to be assigned to the issue.

Once an issue item is assigned, the user or group of users assigned to the item may review 1116 the issue. On review of the issue, the assigned users may resolve 1120 the issue or may transfer 1118 the issue, as an example. Upon transferring 1118, updated assignees may review 1116 the issue again to ensure proper routing of the issue item. In some cases, the issue may be canceled 1122 or it may be linked to another issue for a combined resolution. In some cases, depending on the complexity and/or the type of request, the workflow may include additional steps or less steps. More generally, the request type may dictate the number of steps and workflow used for each of the issue items. Accordingly, building an intake interface may determine the fields displayed in the help desk, the fields visible in the issue tracking system, and the workflow associated with the issue item.

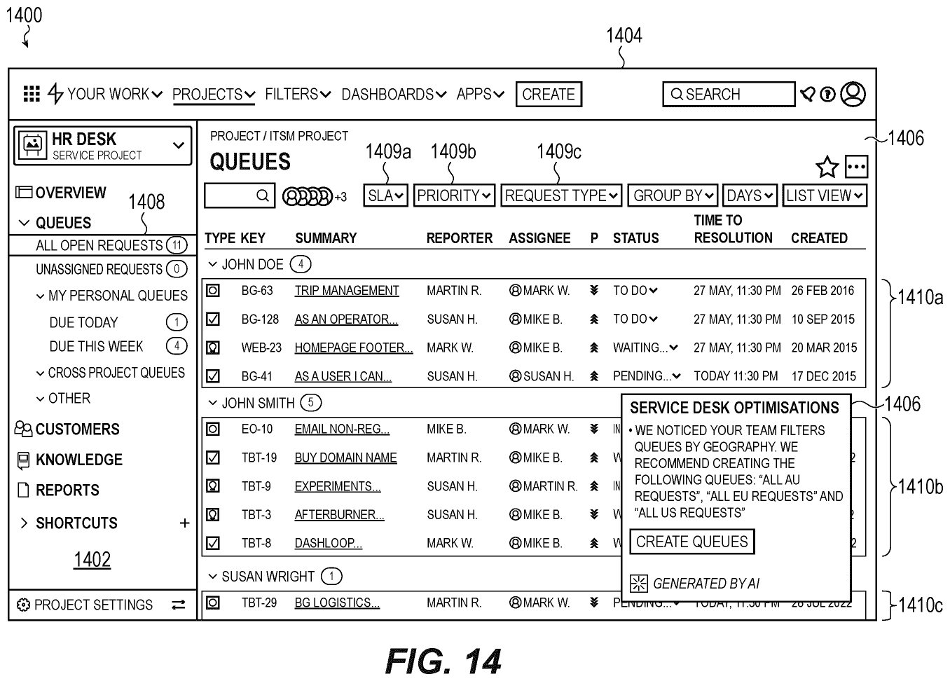

FIG. 14 depicts an example of an issue dashboard graphical user interface 1400 of an issue tracking platform. The issue dashboard GUI 1400 can have various partitions/sections displaying different content. For example, the graphical user interface 1400 may include a navigational panel 1402, a toolbar 1404, and a dashboard data panel 1406. The navigational panel 1402 and the toolbar 1404 can be examples of the navigation panels and toolbars described herein (e.g., navigation panels 602, 702, and toolbars 604, 704).

The navigational panel 1402 may include a hierarchical element tree (also referred to herein a list of issue queues or issue groups) which may be associated with particular issues, one or more issue queues, and/or one or more particular projects, which may be used to manage a set of issues. The hierarchical element tree includes tree elements, which may be selectable to cause display of a corresponding issue or queue. Tree elements may also be referred to herein as selectable elements. Each tree element for the hierarchical element tree may be selectable. In response to a user selection of a respective element of the hierarchical element tree, content of the respective issue or queue may be displayed in the dashboard data panel 1406.

In the example shown in FIG. 14, selectable element 1408 is associated with an issue queue that includes open issue requests associated with a particular project. In some cases, issues may be organized into projects and a particular project can include a subset of issues managed by the issue tracking system. Each project may be associated with a set of user accounts, and users associated with the user accounts may be responsible for handling issues assigned to the project.

In response to an input to the selectable element 1408, the system may display a corresponding issue queue for the particular project in the dashboard data panel 1406. A particular project may be associated with multiple different queues, which may each include a corresponding selectable element that is displayed in the navigation panel 1402. In some cases, the system may display the same queues (and corresponding selectable elements) in the graphical user interfaces for each user, (e.g., on a corresponding client device associated with a user). Accordingly, each user may have access to and/or view the queues associated with a project that they are assigned to. In some cases, a particular user may create additional queues, remove queues, and/or arrange queues in a respective graphical user interface according to personal user preferences, which may be stored by the system.

Each queue managed by the system can be associated with a queue definition that includes one or more defined parameters for determining which issues are displayed in a particular queue. In some cases, the queue definitions can include saved database searches that are set up and have filters or other definitions applied to determine which issues are displayed in the corresponding queue. For example, a queue may include a saved structured query search (e.g., a platform specific query structured query such as JQL) that is set up by an administrative user or other user associated with the particular project.

The dashboard data panel 1406 can include a queue view of issues managed by the issue tracking system. The dashboard panel can display multiple issues 1406 arranged according to a queue definition for the selected queue. For example, the dashboard data panel 1406 shown in FIG. 14 provides an example of issues arranged in queues that each correspond to different agent users of the system. For example, a first queue 1410a includes a first set of issues assigned to a first agent, a second queue 1410b includes a second set of issues assigned to a second agent, and a third queue 1410c includes a third set of issues assigned to a third agent.

In other cases, queue definitions may cause issues to be arranged according to other parameters including a status, priority, request type, SLA, and so on. Accordingly, causing display of the dashboard data panel 1406 in the issue dashboard graphical user interface 1400 can include displaying multiple sets of issue tickets 1410 where each set of issue tickets 1410 is grouped in accordance with a queue definition.

The system can be configured to collect data related to queues including monitoring activity related to each queue and analyze the data and/or activity to generate one or more recommendations for creating and/or modifying the existing queues. In some cases, the system may submit selected queue data to a generative output engine along with a request to analyze the data and suggest changes to the current queue structure and use generative output from the generative output engine to create the one or more recommendations. For example, the system may collect issue data from pending issues, which may include priority information, workflow states, issue activity, messages, SLA information, and so on. The system may submit the issue data and/or corresponding queue data to a generative output engine using a prompt. The system may also include a request such as a request to identify compliance with an SLA, identify duplicate issues across different queues, identify queues with low-utilization, and/or request to analyze the issue and queue data.

The system can analyze a generative response and cause display of a group modification interface including at least a portion of the generative response. The group modification interface can include one or more changes to the current queue structure, including the addition of new queues, removal of existing queues and/or modification or existing queues by modifying and/or creating queue definitions.

The system can collect data and generate a prompt based on a number of different factors. In some cases, the system may define an activity criteria and in response to determining that the activity criteria is satisfied, the system may cause generation of a prompt for submitting to a generative output engine. The activity criteria can be configured in a variety of ways. In some cases, the activity criteria may define a time interval. In these cases, the system may generate and send a prompt each time the time interval is satisfied. Additionally or alternatively the activity criteria can be linked to user activities such as login events and the system may generate and send a prompt in response to login or based on other user interactions with the system. In additional cases, the activity criteria can be tied to project/group and/or issue metrics. For example, the activity criteria can include a defined increase in a number of pending issue tickets, a defined number of issue tickets having a pendency longer than a defined threshold, and so on. In these cases, the system may generate a prompt in response to one or more of these criteria being met. These types of criteria may be configured to cause updates to queue structures in response to real-time changes in the system and these updates to the queue structure can be configured to help address changes in issues such as a sudden increase in issue ticket volume, a significant number of issue tickets approaching or exceeding a SLA, and/or other similar factors.

The system can generate a prompt that includes predetermined prompt text including a recommendation criteria. The recommendation criteria can include instructions and/or request(s) that are submitted to a generative output engine and define the desired output for the generative response. For example, the recommendation criteria can include a request to analyze data extracted from the multiple sets of issue tickets and/or current queues and identify frequently used filter settings for organizing issue tickets associated with a particular project. This type of recommendation criteria may be used to identify queue definitions that are used by some members of the team and suggest that other members, not using currently using the queue definition, configure their instance of the graphical user interface 1400 to include these queue definitions.

In some cases, a prompt that includes a request to identify frequently used filter settings for organizing issue tickets may identify filter settings 1409 configured by the system. For example, the issue tracking system may have a first filter setting 1409a that is configured to organize issue tickets into queues 1410 based on a SLA associated with a respective issue, second filter setting 1409b that is configured to organize issue tickets based on a priority associated with a respective issue, a third filter setting 1409c that is configured to organize issue tickets based on a request type associated with a respective issue. Different users of the system, which are assigned to a same project and/or different projects, may individually configure the various filter settings 1409 to create personalize queues that are displayed in that particular user's instance of the graphical user interface 1400.

In some cases, a particular user or set of users may have filter settings that result in them having higher efficiency or better metrics in one or more areas as compared to other users of the system in progressing and/or resolving issue tickets. For example, a particular user's queue settings may decrease their time to respond to new issue tickets as compared to other user's, increase the number of issue tickets that user resolves compared to other users, decrease that user's time to resolution of an issue ticket, and so on. Accordingly, the system may generate prompts that identify these types of queue definitions that lead to increased productivity, and can use the generative response to suggest these queue definitions to other users of the system.

In some cases, a prompt may include instructions that define a desired output or limit the extent of the output. For example, the prompt can include instructions (e.g., as part of the recommendation criteria) to identify a defined number of filter settings utilized by user of a project, such as the three most used filter setting for users associated with a particular project. Accordingly, the system may user the generative output to identify user accounts associated with the project that are not user one or more of the identified filter settings, and generate a recommendation for a particular user account to update their queue definitions to include these filter settings.

The system can also include prompt data extracted from the multiple sets of issue tickets. The data can include issue data such as an issue title, and agent assigned to the issue, SLA data, workflow data, a summary of the issue, and/or any other suitable data associated with the issue. The data can also include data associated with a current user account authenticated with respect to the frontend application. For example, a permissions profile of an authenticated user (e.g., a role or other user profile data) may be evaluated with respect to permissions for a particular content item like an issue or ticket. A user having a permissions profile that is consistent with the permissions of a content item may be permitted to view, edit, or perform other actions with respect to the content item.

In some cases, the recommendation criteria can include a request to analyze the summaries and identify issue tickets having common issues and the prompt can include an issue summary for each issue ticket of the multiple sets of issue tickets. This prompt can be configured to identify similar issue types, and generate a queue definition that groups issues having similar issue types into an issue group displayed in the graphical user interface 1400. In some cases, the prompt may include a threshold defining a minimum number of issues being identified as having similar issue types to generate a new queue definition.

In some cases, the recommendation criteria can be configured to identify queues and the corresponding queue definitions that are not being utilized by users of the issue tracking system. For example, the prompt can include a request to analyze the data extracted from the multiple sets of issue tickets and identify a queue definition corresponding to a less utilized issue ticket groups (e.g., issue ticket groups/queues that have a usage metric below a defined criteria). This may allow the system to generate a recommendation to remove these queue definitions and corresponding issue ticket groups from the graphical user interface 1400. In some cases, issue tickets may be redundantly displayed in multiple different issue ticket groups based on satisfying queue definitions for each of these issue ticket groups. In some cases, a first issue ticket group may have higher utilization and a second issue ticket group that includes at least some of the same issue tickets as the first issue ticket group may have lower utilization. The prompt can be configured to identify a queue definition corresponding to a less utilized issue ticket group, which may result in the system generating a recommendation to remove the queue definition and corresponding issue ticket group, based on its redundancy and lower utilization.

In some cases, the prompt can be configured to determine difference between a current user associated with the displayed instances of the graphical user interface 1400 and other users of the issue tracking system (e.g., other agents assigned to the same project, agents assigned to projects and/or issues having a same issue request type, and so on). For example, the prompt can include data extracted from the multiple sets of issue tickets including an issue title and assignee for the issue, data associated with a current user account authenticated with respect to the frontend application, and predetermined prompt text including a request to determine differences between queue definitions associated with the current user account and queue definitions associated with other user accounts of the issue tracking platform. The system can, in response to receiving one or more differences for the queue definitions associated with the current user account, cause display of a group modification interface 1412 including at least a portion of the generative response. In response to a user input, the system can cause modification of one or more of the queue definitions associated with the current user account. In some cases, the current user account and the other user accounts are associated with a particular project.

In response to submitting a prompt to a generative output engine, the system can receive a generative response from the generative output engine. The system can analyze the generate response and cause display of a group modification interface 1412 based on content from the generative response. The group modification interface 1412 can be displayed in an instance of the graphical user interface 1400 associated with a particular user account and include suggestions/recommendations for creating, removing and/or modifying current queue definitions corresponding to the issue ticket groups. The group modification interface 1412 can allow a user associated with a particular user account to review and accept or deny the recommended changes to the queue definitions for the graphical user interface 1400. For example, if the generative response includes a recommendation to create a new queue definition, the group modification interface 1412 may include a description of the recommendation to add the new queue definition and a summary of how the new queue definition with operate. In some cases, the system can generate the prompt to include a request for generative output which includes summary text or other text information which can be included in the group modification interface 1412. Accordingly, the system may identify the summary text (or other text) in the generative response and generate the group modification interface 1412 to include that summary text.

The system can receive user input indicating approval/acceptance of the recommendation provided in the group modification interface 1412, and in response to a user input, cause creation of a new issue ticket group and/or modification or an existing issue ticket group. The modification and/or creation of the issue ticket group can include performing a structured query on issues managed by the issue tracking platform and saving the structured query as a new or modified queue definition. In some cases, the structured query is generated using at least a portion of the generative response.

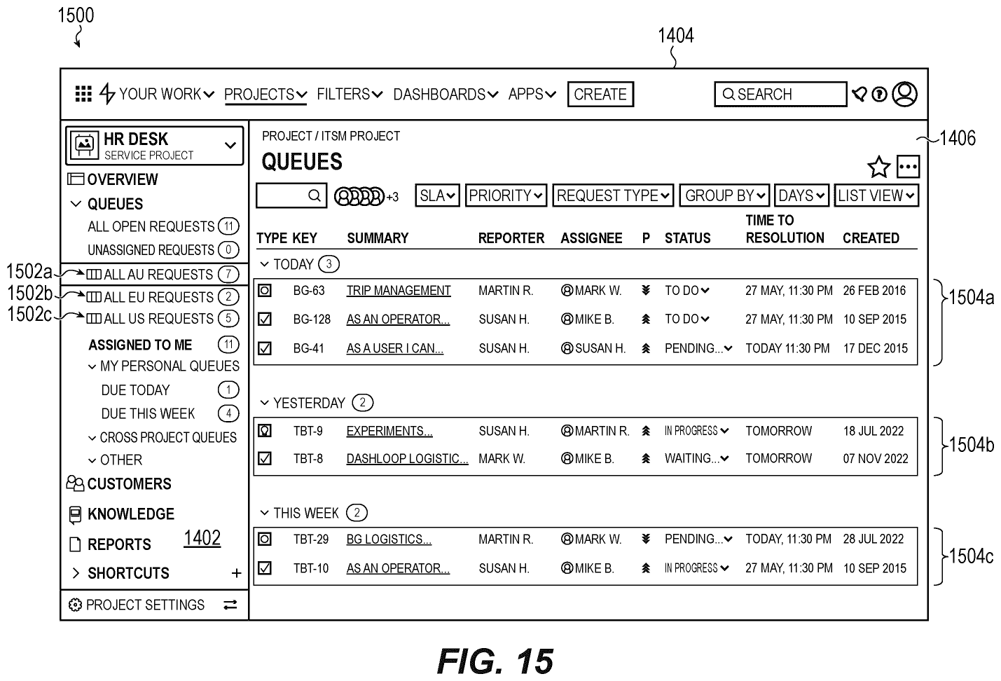

FIG. 15 depicts an example of an updated issue dashboard graphical user interface 1500. The graphical user interface 1500 shows an example of updates to the graphical user interface 1400 as a result of modifying or creating new issue ticket groups based on a generative response.

The graphical user interface 1500 includes new queues 1502 that each include and organize issue tickets based on a new queue definition created by the system using the generative output. In the example, shown in FIG. 15 the system generated a group modification interface 1412 that suggested creating new queue definitions that arranged issues according to geography. For example, arranging issue by geography may help ensure compliance with SLA, since users closer to a respective geography can be assigned issues from that queue. Arranging issue by geography can be based on a generative response that recommended these new queue definitions in response to the generative output engine analyzing issue data and a recommendation criteria include in the prompt. For example, the prompt can have included SLA data, current compliance with SLA parameters and a request to the generative output engine to recommend steps to improve SLA compliance for issues managed by the system. In some cases, the prompt may include issue that are in compliance with a SLA and a group of issues that have lower compliance with a SLA and request the generative output engine to make recommendations for the groups of issues that have lower SLA compliance based on analyzing data from the group of issues that are in compliance.

In response to a user input accepting the request to create the new queue definitions, the system may generate the queues 1502 and display them in the navigation panel 1402 and/or other location of the graphical user interface 1500. For example, the system may create a first new queue 1502a having a queue definition corresponding to a first geographical location, a second new queue 1502b having a queue definition corresponding to a second geographical location, and a third new queue 1502c having a queue definition corresponding to a third geographical location.

In response to a user input to the first new queue 1502a, the system may display issue ticket data 1504 in the dashboard data panel 1406. The first new queue 1502a includes issue ticket data for first issue ticket group. The issue ticket data 1504 may be arranged according to the queue definition for the first new queue 1502a and/or modified using the graphical user interface 1500. The graphical user interface 1504 may, by default, arrange the issue ticket data 1504 according to a due date (e.g., SLA parameter). For example, the graphical user interface 1500 may include a first issue ticket set 1504a having a first due date, a second issue ticket set 1504b having a second issue ticket date and a third issue ticket set 1504c having a third due date.

In some cases, the modification to the one or more of the queue definitions causes the system to change in an order of display for the queues corresponding to the issue ticket groups and displayed in the navigation panel 1402. For example, the system may display queues having issues associated with higher priority arranged higher in the navigation panel. Additionally or alternatively, the system may lock the location of one or more queues in the navigation panel 1402 and/or prevent deletion or modification of corresponding queue definitions. The locking the location or preventing of modification to specific queue definitions may be managed by an administrative user account based on permission associated with the account.

In some cases, a generative output can be used to create or update one or more queue definitions for all members (or a subset of members) associated with a particular project. For example, in response to creation of the new issue ticket group, the system can cause the new queue definition to be associated with each user account assigned to the particular project. The new queue definition can cause the issue dashboard graphical user interface for each respective user assigned to the particular project to display the new issue ticket group. In some cases, new or modified queue definitions based on a generative response may be displayed in the group modification interface on a supervisor account associated with the particular project. The group modification interface 1412 can include an option to cause creation of the new issue ticket group for all users associated with the particular project and an option to deny creation of the new issue ticket group.

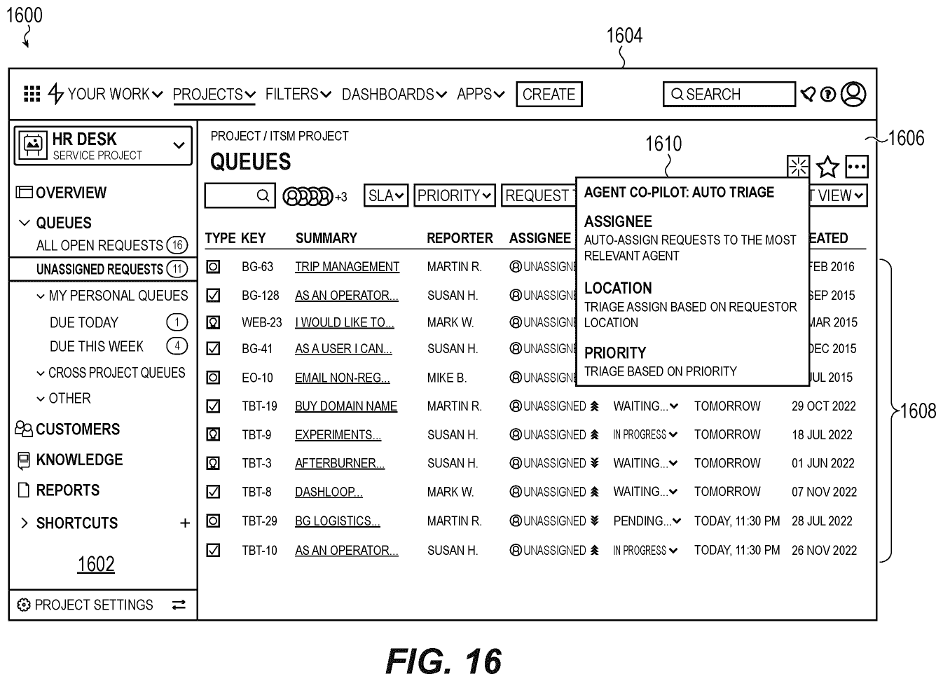

FIG. 16 depicts an example of an issue dashboard graphical user interface 1600 of an issue tracking platform. The issue dashboard GUI 1600 can have various partitions/sections displaying different content. For example, the graphical user interface 1600 may include a navigational panel 1602, a toolbar 1604, and a dashboard data panel 1606. The navigational panel 1602 and the toolbar 1604 can be examples of the navigation panels and toolbars described herein (e.g., navigation panels 602, 702, 1402 and toolbars 604, 704, 1404).

The navigational panel 1602 may include a hierarchical element tree (also referred to herein as a listing of issue queues or issue groups), which may be associated with particular issues, one or more issue queues, and/or one or more particular projects, which may be used to manage a set of issues. The hierarchical element tree includes tree elements, which may be selectable to cause display of a corresponding issue or queue. Tree elements may also be referred to herein as selectable elements. Each tree element for the hierarchical element tree may be selectable. In response to a user selection of a respective element of the hierarchical element tree, content of the respective issue or queue may be displayed in the dashboard data panel 1606.

In the example shown in FIG. 16, selectable element 1602 is associated with an issue queue that includes unassigned issues associated with a particular project. In some cases, issues may be organized into projects and a particular project can include a subset of issues managed by the issue tracking system. Each project may be associated with a set of user accounts, and users associated with the user accounts may be responsible for handling issues assigned to the project.

The system can be configured to suggests actions or assign values to a group of issues based on one or more defined parameters associated with the group of issues. Accordingly, the system may suggest and/or perform bulk action that assign a value or otherwise modify multiple issues. The examples described herein are presented in the context of assigning unassigned issue tickets values based on providing a prompt including issue information to a generative output engine and receiving a generative response. However, these concepts may be applied to issues in other context such as modifying assigned issues to change an agent working on the issue, modify a priority of a pending issue, change a status of assigned issues, and so on.

In response to an input to the selectable element 1602, the system can cause the dashboard data panel 1606 to display unassigned issues tickets 1608. The system can be configured to use issue data associated with the unassigned issue tickets to generate a prompt for a generative response engine. The system can receive a generative response based on the prompt and use content from the generative response to assign the issue tickets 1608. In some cases, the system may automatically generate the prompt based on a user selecting the selectable element 1602. In other cases, the system may include one or more input elements 1610, which can be used to initiate the generation of the prompt and submission of the prompt to a generative output generative output engine. For example, the graphical user interface 1600 can include a menu having multiple input elements 1610 which are each associated with a particular field (e.g., “Assignee,” “Location,” and “Priority”). Selection (or other input) of a particular input element can cause creation of a prompt that uses the respective field to assign the issue tickets 1608.

In some cases, the prompt can include predetermined prompt text that includes grouping instructions, data extracted from the issue tickets 1608, which need to be grouped, which may be referred to as a “first set of issue tickets”, and data extracted from other issue tickets that are have been assigned within the system, which may be referred to as a “second set of issue tickets.” The grouping instructions can include a request of how to group the issue tickets 1608 based on analyzing data extracted from the first set of issue tickets (e.g., issue tickets 1608) and data extracted from the second set of issue tickets (e.g., already assigned issue tickets). In this regard, the prompt may include information relevant to grouping the first set of issues tickets, such as which assignee(s) the second set of issue tickets are associated with, priorities assigned to the second set of issue tickets, assigned location of the second set of issue tickets, workflow data (e.g., current status, activities, SLA info, state transitions, transaction message data, and/or other event data), and so on.

In a first set of examples, the user may select an input element 1610 associated with an assignee field, and the prompt can be configured to assign issues of the first set of issues to different user accounts, which may also be referred to as a value associated with the assignee field. That is each user account me be associated with a value and assigning the issue tickets can include assigning each issue ticket to a value that corresponds to a user account. In these cases, the second set of issues may already be associated with user accounts—e.g., assigned a value associated with the assignee field. The prompt may include a request to assign each of the first set of issues (associated with issue tickets 1608) to a particular value (e.g., user account) based on data from these issues along with data from already assigned issues (the second set of issue).

In some cases, the prompt may identify a set of user accounts, which can include a set of user accounts assigned to a particular project. In these cases, the first set of issue tickets 1608 is assigned to the set of users associated with the particular project, and the second set of issue data can also be associated with the particular project. Accordingly, the generative output relates directly to activity occurring within the particular project.

In some cases, the field can be associated with priority metric that can be assigned to each issue and the generative response can be used to assign issues of the first set of issues 1608 a priority value. Assigning a priority value may be in addition to or as an alternative to assigning each issue to a particular user account. In other cases, the field can be associated with a location metric that can be assigned to each issue and the generative response can be used to assign issues of the first set of issues 1608 a location value, which may correspond to different geographical locations. For example, the geographical location assignment may ensure that an issue ticket is assigned to an assignee, project, team within a defined location, which may help with SLA compliance and/or other factors related to resolving a particular issue. Assigning a location value may be in addition to or as an alternative to assigning each issue a particular assignee and/or priority value.

Providing data, within the prompt, extracted from the first set of issue tickets 1608 and data extracted from the second set of issues can help ensure that assignments, priorities, locations and/or other factors are balanced between users accounts and/with already assigned/active issues for a project. For example, the prompt may include a request to assign the first set of issues to distribute priorities and SLA response times evenly across user accounts associated with a project, which may help ensure that issues are meeting SLA metrics. Additionally or alternatively, the prompt may include a request to identify types of issues (e.g., an expertise) associated with one or more particular users and to categorize the first set of issue into issue types and assign the first set of issue based on matching issue types with an expertise determined for a particular user account.

The system can receive a generative response from a generative output engine in response to submitting the prompt. The system may analyze the generative response and arrange the issues of the first set of issues 1608 into multiple groups of issue tickets based on the generative response. For example, the generative response may assign each of the first set of issue a value associated with a particular field, which may be a value associated with a particular user account, a value associated with a priority level, a value associated with a particular location, and/or a combination thereof. In response to assigning each of the first set of issues a value, the system may display a field assignment interface indicating the assigned features of each issue.

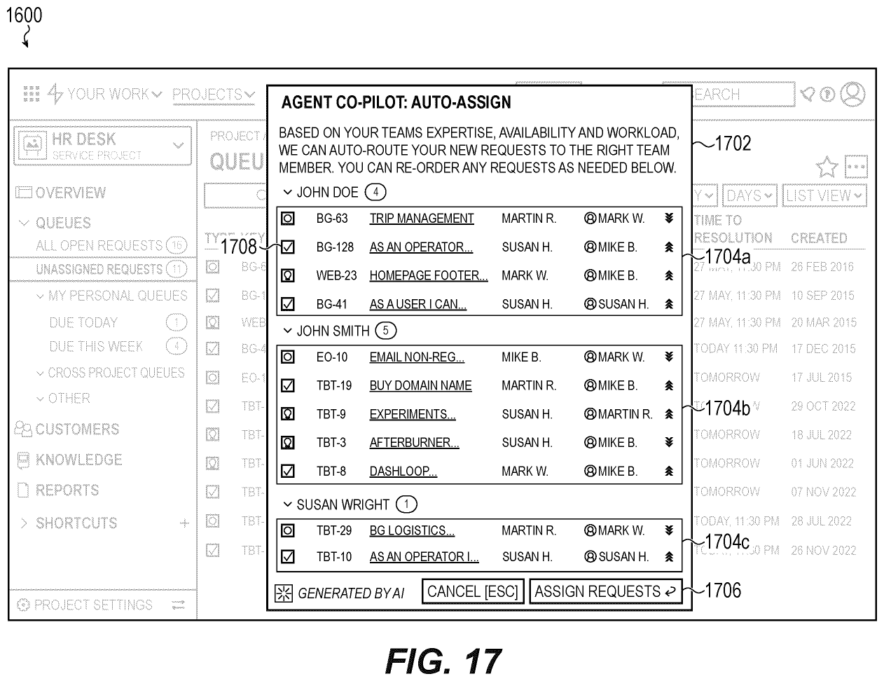

FIG. 17 depicts an example of a field assignment interface 1702 displayed in response to obtaining a generative response from a generative output engine. The field assignment interface 1702 can include issue tickets from the first set of issue tickets 1608 arranged into multiple groups of issue tickets 1704. Each group of issue tickets 1704 can be associated with a particular value assigned to a respective issue. The example shown in FIG. 17, depicts issue assigned according to an assignee (user account field) and each issue is assigned a value associated with a particular user account. For example, a first set of issues 1704a are each assigned a value corresponding to a first user account, a second set of issues 1704b are each assigned a value corresponding to a second user account and a third set of issues 1704c are each assigned a value corresponding to a third user account.

In some cases, the field assignment interface 1702 includes a selectable element 1706 to accept the proposed assignments, and in response to a user input to the selectable element 1706, the system assigns the respective values to the corresponding issue. Accordingly, the first set of issues 1608 are assigned based on the field associated with the value.

The assignment interface 1702 can indicate a temporary/suggest assignment of issues prior to the issues being assigned (e.g., via the selectable element 1706). In some cases, the assignment interface 1702 can be configured to allow changes to the proposed issue groups 1704 that were created from the generative response. For example, each issue may include an element 1708 that allows the issue to be moved, and therefore assigned, to a different value (e.g., user account). For example, a user input to the graphical user interface 1700 can be used to move the corresponding issue to another group and the system updates the value for the issue accordingly. The assignment interface 1702 may include tools (graphical element) for removing issue from assignment, modifying data associated with an issue, and/or performing other actions with respect to an issue.

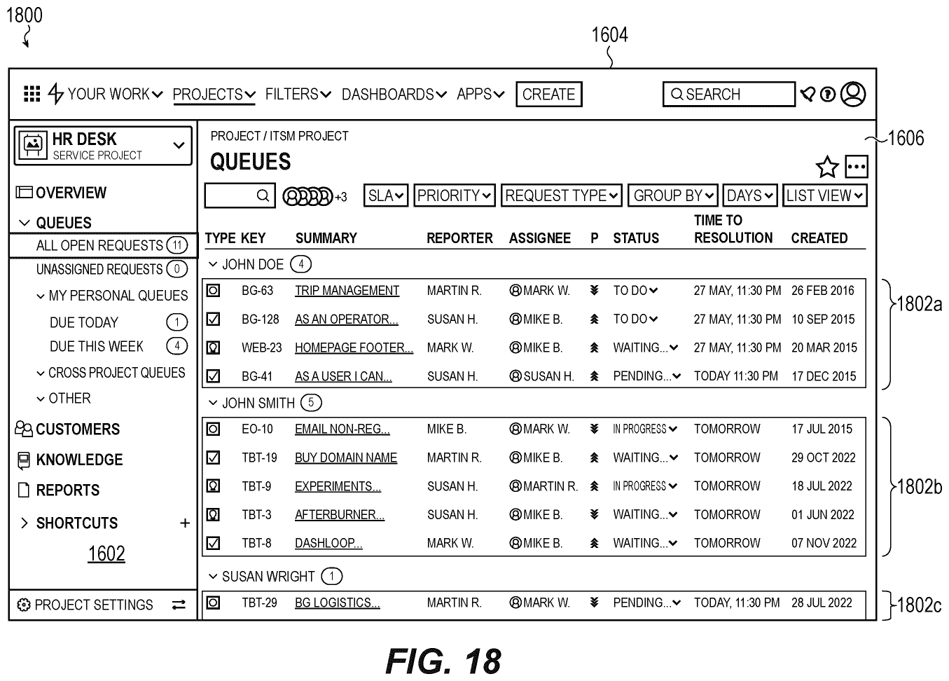

FIG. 18 depicts an example of an issue dashboard graphical user interface 1800 having issue tickets arranged into multiple groups of issue tickets 1802. The graphical user interface 1800 can be displayed in response to a user input to the selectable element 1706 causing assignment of the first set of issues 1608. The dashboard data panel 1606 can be updated to display the assigned issues based on the assignments shown in the assignment interface. The dashboard data panel can include a first set of issue tickets 1802a assigned a first value (e.g., corresponding to a first user account), a second set of issue tickets 1802b assigned a second value (e.g., corresponding to a second user account) and a third set of issue tickets 1802c assigned a third value (e.g., corresponding to a third user account).

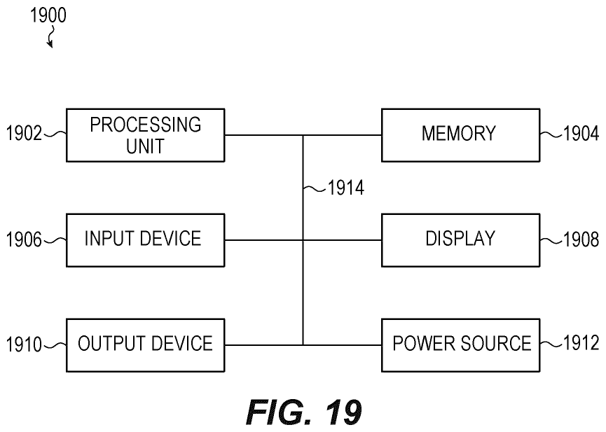

FIG. 19 shows a sample electrical block diagram of an electronic device 1900 that may perform the operations described herein. The electronic device 1900 may in some cases take the form of any of the electronic devices described with reference to FIGS. 1-18 including client devices, and/or servers or other computing devices associated with the collaboration system 190. The electronic device 1900 can include one or more of a processing unit 1902, a memory 1904 or storage device, input devices 1906, a display 1908, output devices 1910, and a power source 1912. In some cases, various implementations of the electronic device 1900 may lack some or all of these components and/or include additional or alternative components.

The processing unit 1902 can control some or all of the operations of the electronic device 1900. The processing unit 1902 can communicate, either directly or indirectly, with some or all of the components of the electronic device 1900. For example, a system bus or other communication mechanism 1914 can provide communication between the processing unit 1902, the power source 1912, the memory 1904, the input device(s) 1906, and the output device(s) 1910.

The processing unit 1902 can be implemented as any electronic device capable of processing, receiving, or transmitting data or instructions. For example, the processing unit 1902 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1900 can be controlled by multiple processing units. For example, select components of the electronic device 1900 (e.g., an input device 1906) may be controlled by a first processing unit and other components of the electronic device 1900 (e.g., the display 1908) may be controlled by a second processing unit, where the first and second processing units may or may not be in communication with each other.

The power source 1912 can be implemented with any device capable of providing energy to the electronic device 1900. For example, the power source 1912 may be one or more batteries or rechargeable batteries. Additionally, or alternatively, the power source 1912 can be a power connector or power cord that connects the electronic device 1900 to another power source, such as a wall outlet.

The memory 1904 can store electronic data that can be used by the electronic device 1900. For example, the memory 1904 can store electronic data or content such as, for example, audio and video files, documents and applications, device settings and user preferences, timing signals, control signals, and data structures or databases. The memory 1904 can be configured as any type of memory. By way of example only, the memory 1904 can be implemented as random access memory, read-only memory, flash memory, removable memory, other types of storage elements, or combinations of such devices.

In various embodiments, the display 1908 provides a graphical output, for example associated with an operating system, user interface, and/or applications of the electronic device 1900 (e.g., a chat user interface, an issue-tracking user interface, an issue-discovery user interface, etc.). In one embodiment, the display 1908 includes one or more sensors and is configured as a touch-sensitive (e.g., single-touch, multi-touch) and/or force-sensitive display to receive inputs from a user. For example, the display 1908 may be integrated with a touch sensor (e.g., a capacitive touch sensor) and/or a force sensor to provide a touch- and/or force-sensitive display. The display 1908 is operably coupled to the processing unit 1902 of the electronic device 1900.

The display 1908 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1908 is positioned beneath and viewable through a cover that forms at least a portion of an enclosure of the electronic device 1900.

In various embodiments, the input devices 1906 may include any suitable components for detecting inputs. Examples of input devices 1906 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1906 may be configured to detect one or more particular types of input and provide a signal (e.g., an input signal) corresponding to the detected input. The signal may be provided, for example, to the processing unit 1902.

As discussed above, in some cases, the input device(s) 1906 include a touch sensor (e.g., a capacitive touch sensor) integrated with the display 1908 to provide a touch-sensitive display. Similarly, in some cases, the input device(s) 1906 include a force sensor (e.g., a capacitive force sensor) integrated with the display 1908 to provide a force-sensitive display.

The output devices 1910 may include any suitable components for providing outputs. Examples of output devices 1910 include light emitters, audio output devices (e.g., speakers), visual output devices (e.g., lights or displays), tactile output devices (e.g., haptic output devices), communication devices (e.g., wired, or wireless communication devices), and so on, or some combination thereof. Each output device 1910 may be configured to receive one or more signals (e.g., an output signal provided by the processing unit 1902) and provide an output corresponding to the signal.

In some cases, input devices 1906 and output devices 1910 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1902 may be operably coupled to the input devices 1906 and the output devices 1910. The processing unit 1902 may be adapted to exchange signals with the input devices 1906 and the output devices 1910. For example, the processing unit 1902 may receive an input signal from an input device 1906 that corresponds to an input detected by the input device 1906. The processing unit 1902 may interpret the received input signal to determine whether to provide and/or change one or more outputs in response to the input signal. The processing unit 1902 may then send an output signal to one or more of the output devices 1910, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method for providing generative content for a graphical user interface of an issue tracking platform, the method comprising:
causing display of an intake portal graphical user interface of a frontend application of the issue tracking platform on a client device;
in response to a first user input provided to the intake portal graphical user interface, causing creation of a particular issue;
causing display of an issue-view graphical user interface comprising issue data of the particular issue, the issue data comprising transaction messages associated with the particular issue;
generating a first prompt comprising:
a set of similar issues to the particular issue, the set of similar issues identified using semantic analysis of the issue data; and
a request to extract actions performed for each issue of the set of similar issues;
receiving a first generative response produced in response to providing the first prompt to a generative output engine, the first generative response including a summary of actions performed for each issue of the set of similar issues;
in response to receiving the first generative response, generating a second prompt comprising:
issue data extracted from the particular issue;
the summary of actions received as part of the first generative response; and
predetermined prompt language associated with a recommendation request;
receiving a second generative response produced in response to providing the second prompt to the generative output engine; and
causing display of a recommendation panel in the issue-view graphical user interface, the recommendation panel comprising content generated using the second generative response.

2. The computer-implemented method of claim 1, wherein identifying the set of similar issues comprises using the semantic analysis to identify issues that are managed by the issue tracking platform and that have a resolved status.

3. The computer-implemented method of claim 2, wherein identifying the set of similar issues comprises identifying issues that are each associated with a respective date that satisfies a defined timeframe for resolving the particular issue.

4. The computer-implemented method of claim 1, the request to extract actions performed for each issue of the set of similar issues comprises an identification of one or more action types.

5. The computer-implemented method of claim 4, wherein the one or more action types comprise actions performed by a user of the issue tracking system, an automation performed for a respective issue, a request to send to a remote system, and a status transition for the respective issue.

6. The computer-implemented method of claim 1, wherein the first prompt comprises:
the issue data for the particular issue; and
a second request to provide a similarity ranking between each issue of the set of similar issues and the particular issue using the issue data.

7. The computer-implemented method of claim 6, wherein:
the second prompt comprises a request to identify an action that led to resolution for issues of the set of similar issues;
the second generative response comprises a set of summaries comprising a respective summary of the action that led to resolution for each of the issues of the set of similar issues; and
the recommendation panel comprises the set of summaries.

8. The computer-implemented method of claim 1, wherein:
the recommendation request comprises a request to recommend a next action to perform for the particular issue; and
the recommendation panel comprises the next action to perform for the particular issue.

9. The computer-implemented method of claim 1, further comprising:
generating a user message for display in the intake portal graphical user interface using the second generative response, the user message comprising a suggested action narrative and agent information; and
the recommendation panel comprises an option to cause the user message to be displayed in the intake portal graphical user interface.

10. A computer-implemented method for providing generative content for a graphical user interface of an issue tracking platform, the method comprising:
causing display of an intake portal graphical user interface of a frontend application of the issue tracking platform on a client device;
in response to a first user input provided to the intake portal graphical user interface, causing creation of a particular issue;
causing display of an issue-view graphical user interface comprising issue data of the particular issue, the issue data comprising transaction messages associated with the particular issue;
generating a first prompt comprising:
a set of similar issues to the particular issue, the set of similar issues identified using semantic analysis of the issue data; and
a request to extract issue data comprising action and result pairs for issues of the set of similar issues;
receiving a first generative response produced in response to providing the first prompt to a generative output engine, the first generative response including issue data for issues of the set of similar issues;
in response to receiving the first generative response, generating a second prompt comprising:
issue data extracted from the particular issue;
the issue data for the set of similar issues received as part of the first generative response; and
predetermined prompt language associated with a recommendation request;
receiving a second generative response produced in response to providing the second prompt to the generative output engine; and
causing display of a recommendation panel in the issue-view graphical user interface, the recommendation panel comprising content generated using the second generative response.

11. The computer-implemented method of claim 10, wherein the action and result pairs for issues of the set of similar issues comprise an activity performed on a respective issue and a resulting issue state transition.

12. The computer-implemented method of claim 11, wherein the activity performed on the respective issue comprises at least one of a transaction message, performing an automation associated with the respective issue, an approval, a reference to a knowledge base resource, or a combination thereof.

13. The computer-implemented method of claim 10, wherein the first prompt comprises:
the issue data for the particular issue; and
a second request to provide a similarity ranking between each issue of the set of similar issues and the particular issue using the issue data.

14. The computer-implemented method of claim 10, wherein:
the second prompt comprises a request to identify an action that led to resolution for issues of the set of similar issues;
the second generative response comprises a set of summaries comprising a respective summary of an action that led to resolution for each of the issues of the set of similar issues; and
the recommendation panel comprises the set of summaries.

15. The computer-implemented method of claim 10, further comprising generating a user message for display in the intake portal graphical user interface using the second generative response, the user message comprising a suggested action narrative and agent information.

16. The computer-implemented method of claim 15, wherein:
the recommendation request comprises a request to recommend a next action to perform for the particular issue; and
the user message comprises at least a portion of the recommended next action.

17. An issue tracking platform comprising:
an issue tracking backend application operating on one or more servers, the issue tracking backend application operably coupled to a frontend application operating on a client device, the issue tracking backend application configured to:
cause display of an intake portal graphical user interface of the frontend application of the issue tracking platform on the client device;
in response to a first user input provided to the intake portal graphical user interface, cause creation of a particular issue;
cause display of an issue-view graphical user interface comprising issue data of the particular issue, the issue data comprising transaction messages associated with the particular issue;
generate a first prompt comprising:
a set of similar issues to the particular issue, the set of similar issues identified using semantic analysis of the issue data; and
a request to extract actions performed for each issue of the set of similar issues;
receive a first generative response produced in response to providing the first prompt to a generative output engine, the first generative response including a summary of actions performed for each issue of the set of similar issues;
in response to receiving the first generative response, generate a second prompt comprising:
issue data extracted from the particular issue;
the summary of actions received as part of the first generative response; and
predetermined prompt language associated with a recommendation request;
receive a second generative response produced in response to providing the second prompt to the generative output engine; and
cause display of a recommendation panel in the issue-view graphical user interface, the recommendation panel comprising content generated using the second generative response.

18. The issue tracking platform of claim 17, wherein identifying the set of similar issues comprises using the semantic analysis to identify issues that are managed by the issue tracking platform and that have a resolved status.

19. The issue tracking platform of claim 18, wherein:
the recommendation request comprises a request to recommend a next action to perform for the particular issues; and
the recommendation panel comprises the next action to perform for the particular issue.

20. The issue tracking platform of claim 17, wherein the issue tracking backend application is configured to generate a user message for display in the intake portal graphical user interface using the second generative response, the user message comprising a suggested action narrative and agent information.
